(19) United States
(12) Patent Application Publication
(10) Pub. No.: US 2026/0145085 A1
(43) Pub. Date: May 28, 2026

(54) VIRTUAL GAME CONTROL METHOD AND APPARATUS, STORAGE MEDIUM, AND ELECTRONIC DEVICE

(71) Applicant: NETEASE (HANGZHOU) NETWORK CO., LTD., Hangzhou (CN)

(72) Inventor: Zicong DENG, Hangzhou (CN)

(21) Appl. No.: 18/993,974

(22) PCT Filed: Mar. 6, 2023
(86) PCT No.: PCT/CN2023/079900

§ 371 Date: Dec. 3, 2025

(30) Foreign Application Priority Data
Jul. 18, 2022 (CN) 202210845222.8

(51) Int. Cl. A63F 13/812

(52) U.S. Cl. CPC A63F 13/812

(57) ABSTRACT

In the present disclosure, a virtual game picture of a virtual competitive sports game is displayed on a graphical user interface of an electronic device. When a competitive side controlled by a virtual user of the electronic device is an attacking side, on the basis of virtual field areas of the virtual competitive sports game, determining a target termination area for the attacking side to execute a finishing competitive movement, and determining a target virtual object; and controlling the target virtual object to execute a pre-movement of the finishing competitive movement, or to execute the finishing competitive movement in the target termination area.

The present disclosure claims priority to Chinese Patent Application filed with the China National Intellectual Property Administration on Jul. 18, 2022, with application number 202210845222.8 and entitled “VIRTUAL GAME CONTROL METHOD AND APPARATUS, STORAGE MEDIUM, AND ELECTRONIC DEVICE”, which is incorporated herein by reference in its entirety.

### TECHNICAL FIELD

The present disclosure relates to the technical field of virtual games, and in particular, to a virtual game control method and apparatus, a computer-readable storage medium, and an electronic device.

### BACKGROUND

With the development of computer technology, virtual games have become increasingly important. People often use virtual games for entertainment during their leisure time or to learn skills involved in the games.

In virtual games, such as virtual competitive sports games like basketball and football, there are typically buff functions. Currently, most of these functions are applied to enhance certain player attributes, do not provide additional methods for acquiring better offensive opportunities, resulting in a less satisfying virtual gaming experience and a reduced human-computer interaction efficiency.

### Technical Problem

The embodiments of the present disclosure provide a virtual game control method and apparatus, a computer-readable storage medium, and an electronic device, which can determine better offensive opportunities through alternative methods, and improve the accuracy and efficiency of determining better offensive opportunities, thereby enhancing the gaming experience, and enhancing the human-computer interaction efficiency.

### Technical Solutions

In a first aspect, an embodiment of the present disclosure provides a virtual game control method, including:
presenting a virtual game screen corresponding to a virtual competitive sports game on a graphical user interface of an electronic device, where the virtual game screen includes part or all of a virtual field area of the virtual competitive sports game, and the virtual competitive sports game includes at least two competing sides;
when a competing side controlled by a virtual user corresponding to the electronic device is an offensive side, determining, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense;
determining, from at least one virtual object manipulated by the offensive side, a target virtual object that matches the target finishing zone; and
controlling the target virtual object to execute a preparatory action for the finishing competitive action, or controlling the target virtual object to execute the preparatory action and to execute the finishing competitive action in the target finishing zone.

In a second aspect, an embodiment of the present disclosure further provides a virtual game control apparatus, including:
a presentation module configured to present a virtual game screen corresponding to a virtual competitive sports game on a graphical user interface of an electronic device, where the virtual game screen includes part or all of a virtual field area of the virtual competitive sports game, and the virtual competitive sports game includes at least two competing sides;
a zone determination module configured to, when a competing side controlled by a virtual user corresponding to the electronic device is an offensive side, determine, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense;
an object determination module configured to determine, from at least one virtual object manipulated by the offensive side, a target virtual object that matches the target finishing zone; and
a control module configured to control the target virtual object to execute a preparatory action for the finishing competitive action, or control the target virtual object to execute the preparatory action and to execute the finishing competitive action in the target finishing zone.

In a third aspect, an embodiment of the present disclosure further provides a computer-readable storage medium storing a computer program, where the computer program is suitable for being loaded by a processor to execute the steps of the virtual game control method according to any embodiment as described above.

In a fourth aspect, an embodiment of the present disclosure further provides an electronic device, including a memory and a processor, where the memory stores a computer program, and the processor, by invoking the computer program stored in the memory, executes the steps of the virtual game control method according to any embodiment as described above.

### Beneficial Effects

The virtual game control method and apparatus, a computer-readable storage medium, and an electronic device according to the embodiments of the present disclosure are implemented by presenting a virtual game screen corresponding to a virtual competitive sports game on a graphical user interface of an electronic device, where the virtual game screen includes part or all of a virtual field area of the virtual competitive sports game, and the virtual competitive sports game includes at least two competing sides; when a competing side controlled by a virtual user corresponding to the electronic device is an offensive side, determining, based on the virtual field area, a selected target finishing zone for the offensive side to execute a finishing competitive action, and determining, from at least one virtual object manipulated by the offensive side, a target virtual object that matches the target finishing zone; and controlling the target virtual object to execute a preparatory action for the finishing competitive action, or controlling the target virtual object to execute the preparatory action and to execute the finishing competitive action in the target finishing zone. In the embodiments of the present disclosure, a target finishing zone for executing a finishing competitive action can be selected, and a target virtual object matching the target finishing zone can be determined, and the target virtual object can be controlled to execute the finishing competitive action in the target finishing zone. This enables active selection of the target finishing zone while achieving the selection of a better target virtual object to determine better offensive opportunities. The embodiments of the present disclosure determine better offensive opportunities in a virtual competitive sports game in a novel manner, improving the accuracy and efficiency of determining better offensive opportunities, thereby improving the gaming experience and enhancing the human-computer interaction efficiency.

### BRIEF DESCRIPTION OF THE DRAWINGS

In order to more clearly illustrate the technical solutions in the embodiments of the present disclosure, a brief description of the accompanying drawings used in the description of the embodiments is provided below. Apparently, the accompanying drawings described below are merely some embodiments of the present disclosure. For those skilled in the art, other accompanying drawings can be obtained based on these accompanying drawings without requiring creative efforts.

FIG. 1 is a schematic diagram of an application scenario according to one of the embodiments of the present disclosure.

FIG. 2 is a schematic flowchart of a virtual game control method according to one of the embodiments of the present disclosure.

FIG. 3 is a schematic diagram of a tactical zone panel of a basketball game according to one of the embodiments of the present disclosure.

FIG. 4 is a schematic sub-flowchart of a virtual game control method according to one of the embodiments of the present disclosure.

FIG. 5 is a schematic diagram of a zone matching control according to one of the embodiments of the present disclosure.

FIG. 6 is a schematic diagram of presenting a tactical zone panel on the virtual game screen in an overlaid manner according to one of the embodiments of the present disclosure.

FIG. 7 is another schematic flowchart of a virtual game control method according to one of the embodiments of the present disclosure.

FIG. 8 is a schematic diagram of candidate tactics supported on the graphical user interface in a certain target finishing zone according to one of the embodiments of the present disclosure.

FIG. 9 is a schematic diagram of displaying the tactic type and the tactic name of a target tactic in a virtual game screen according to one of the embodiments of the present disclosure.

FIG. 10 is another schematic sub-flowchart of a virtual game control method according to one of the embodiments of the present disclosure.

FIG. 11 is a schematic diagram of starting positions of players in a starting point of the target tactic according to one of the embodiments of the present disclosure.

FIG. 12 is a schematic diagram of the current positions of players according to one of the embodiments of the present disclosure.

FIG. 13 is a schematic diagram of a tactic browsing control and a tactical panel according to one of the embodiments of the present disclosure.

FIG. 14 is a schematic flowchart of a virtual game control method according to one of the embodiments of the present disclosure.

FIG. 15 is a schematic diagram of a virtual object designation control, virtual object identifiers, and a tactical panel according to one of the embodiments of the present disclosure.

FIG. 16 is a structural schematic diagram of a virtual game control apparatus according to one of the embodiments of the present disclosure.

FIG. 17 is a structural schematic diagram of a control module according to one of the embodiments of the present disclosure.

FIG. 18 is a structural schematic diagram of an electronic device according to one of the embodiments of the present disclosure.

### DETAILED DESCRIPTION

The technical solutions in the embodiments of the present disclosure will be described clearly and completely below with merely reference to the accompanying drawings in the embodiments of the present disclosure. Apparently, the embodiments described are some rather than all of the embodiments of the present disclosure. All other embodiments obtained by those skilled in the art based on the embodiments in the present disclosure without any creative effort shall fall within the scope of protection of the present disclosure.

Embodiments of the present disclosure provide a virtual game control method and apparatus, a computer-readable storage medium, and an electronic device. Specifically, the virtual game control method in the embodiments of the present disclosure can be executed by an electronic device, where the electronic device may be a terminal or a server, among other devices. The terminal may be a smart phone, a tablet computer, a laptop computer, a touch screen, a gaming console, a personal computer (PC), a personal digital assistant (PDA), etc. The server may be a stand-alone physical server, or a server cluster or distributed system consisting of multiple physical servers, or a cloud server that provides basic cloud computing services, such as cloud services, cloud databases, cloud computing, and cloud storage.

For example, when the virtual game control method is running on a terminal, the terminal is used to implement the virtual game control method in the embodiments of the present disclosure. Alternatively, when the virtual game control method is running on a terminal, the terminal stores a game application and is configured to present the virtual game screen. The game application can implement the virtual game control method described in the present disclosure. The terminal is configured to interact with the user through a graphical user interface. There may be multiple ways for the terminal to provide the graphical user interface to the user. For example, it can be rendered and displayed on the display screen of the terminal, or the graphical user interface can be presented through holographic projection.

For example, when the virtual game control method is running on a server, it may be cloud gaming. In the operation mode of cloud gaming, the running entity of the game application is separate from the presentation entity of the virtual game screen. The storage and execution of the virtual game control method are completed on the cloud gaming server, while the presentation of the virtual game screen is completed on the client of the cloud gaming. During gameplay, the user operates the cloud gaming client to send operation commands for corresponding operations to the cloud gaming server. The cloud gaming server runs the game based on the operation commands, encodes and compresses the game screen and other data, and transmits them back to the cloud gaming client via the network. Finally, the cloud gaming client performs decoding and outputs the virtual game screen. In this way, the consumption of computational resources of the terminal is reduced and the screen quality of the screen displayed on the terminal is improved.

The following provides a detailed description of the virtual game control method and apparatus, the computer-readable storage medium, and the electronic device according to the embodiments of the present disclosure. It should be noted that the sequence numbers of the following embodiments do not limit the preferred order of the embodiments.

FIG. 1 is a schematic diagram of an application scenario according to an embodiment of the present disclosure, in which the virtual game control method is running on an electronic device. The user corresponding to the electronic device, such as the holder user of the electronic device, can register a virtual user on the electronic device. The virtual user is a virtual player user, such as a virtual player user in a virtual competitive game. The holder user interacts with the electronic device through the graphical user interface of the electronic device by manipulating the virtual player user, such as executing various trigger operations on the graphical user interface, thereby enabling the electronic device to respond to the corresponding trigger operations to implement the virtual game control method described in the present disclosure.

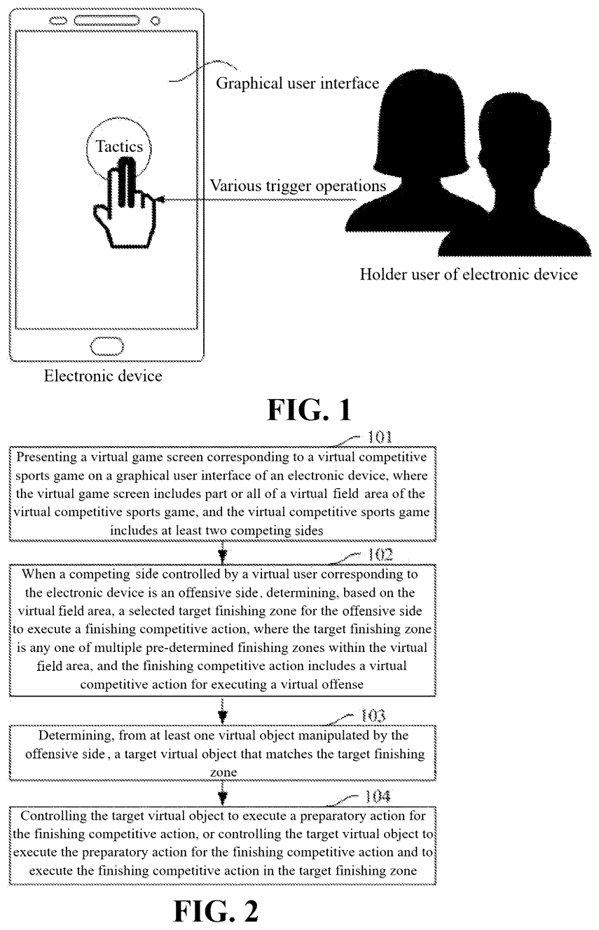

FIG. 2 is a schematic flowchart of a virtual game control method according to an embodiment of the present disclosure. The virtual game control method includes the following steps.

101: Presenting a virtual game screen corresponding to a virtual competitive sports game on a graphical user interface of an electronic device, where the virtual game screen includes part or all of a virtual field area of the virtual competitive sports game, and the virtual competitive sports game includes at least two competing sides.

Virtual competitive sports games, also referred to as “active competitive games”, are a type of rule-based game. The fundamental elements that constitute virtual competitive sports games include physical activity, storyline, rules, methods, outcomes, fields, and competitive objects. Among these, physical activity is an indispensable component of virtual competitive sports games. Virtual competitive sports games can be categorized based on their characteristics, such as classifications according to basic human activities like running, jumping, throwing, and others.

Most popular physical competitive sports in real life are incorporated into virtual competitive sports games, such as basketball games, tennis games, golf games, football games, rugby games, racing games, and others. The corresponding virtual competitive objects are respectively basketballs, tennis balls, golf balls, footballs, rugby balls, racing vehicles, etc., while the corresponding virtual field areas are respectively basketball courts, tennis courts, golf courses, football fields, rugby fields, racing tracks, and so on. Virtual competitive sports games also include virtual games such as boxing and swimming, which do not have clearly defined virtual competitive objects. The corresponding virtual field areas include boxing rings, swimming pools, and others.

In virtual competitive sports games, at least one virtual object or a group formed by multiple virtual objects participating in physical competitions can serve as one competing side. Virtual competitive sports games include at least two competing sides. For example, games such as basketball games, tennis games, and football games include two competing sides, while games such as racing games and swimming games may include two or more competing sides. Each competing side includes one virtual object or multiple virtual objects. For instance, in basketball games and football games, each competing side includes multiple virtual objects, whereas in singles tennis games, each competing side includes one virtual object. Virtual objects can simulate real physical competitive activities to achieve the purpose of earning points in the virtual game scene. When the points of a virtual object in the virtual game scene meet certain conditions, the virtual object either wins or loses in the virtual game scene.

Correspondingly, one electronic device/client can control one or more virtual objects in the virtual game scene, or one virtual user, i.e., a virtual player user, can control one or more virtual objects in the virtual game scene. For example, in a basketball game, one electronic device can control multiple virtual objects in one team, such as five virtual objects.

The virtual game scene can be a simulated environment scene of a real-world environment, a semi-simulated and semi-fictional environment scene, or a purely fictional environment scene. The virtual game scene can be any of a two-dimensional virtual scene, a 2.5-dimensional virtual scene, or a three-dimensional virtual scene. A virtual object refers to a movable object within the virtual game scene, which varies depending on the specific environmental scene. For example, it can be at least one of a virtual character, a virtual animal, or a virtual vehicle such as a car. When the virtual game scene is a three-dimensional virtual scene, the corresponding virtual object can be a three-dimensional virtual object composed of a three-dimensional model.

On the graphical user interface of the electronic device, the virtual game screen corresponding to the virtual competitive sports game is presented. The virtual game screen represents all or part of the virtual game scene. Correspondingly, the virtual game screen includes part or all of the virtual field area of the virtual competitive sports game. The virtual field area can be, for example, the basketball court in a basketball game, the football field in a football game, etc., as specifically described in the aforementioned content.

102: When a competing side controlled by a virtual user corresponding to the electronic device is an offensive side, determining, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense.

The virtual user corresponding to the electronic device can be the virtual player user currently logged into the electronic device. As described above, one virtual user/client/electronic device can control one or more virtual objects in the virtual game scene. For example, in a basketball game, one virtual user controls five virtual objects of a team.

Since it is a virtual competitive sports game, the competing sides include an offensive side and may also include a defensive side, among others. In the embodiments of the present disclosure, the description is provided taking the offensive side as an example, and the defensive side will not be described.

when a competing side controlled by a virtual user corresponding to the electronic device is an offensive side, a selected target finishing zone is determined based on the virtual field area, where the target finishing zone is any one of multiple pre-determined finishing zones within the virtual field area. In the target finishing zone, the offensive side executes the finishing competitive action/move of the virtual offense corresponding to the virtual competitive sports game. The finishing competitive action includes a virtual competitive action executing the virtual offense, such as any one or more actions (virtual competitive actions) or a series of coherent actions formed by multiple actions that finish this offensive play. The finishing competitive move includes a virtual competitive move executing the virtual offense, such as any one or more moves (virtual competitive moves) or a series of coherent moves formed by multiple moves that finish this offensive play.

Taking a basketball game as an example, the finishing zone refers to a zone within the virtual field area where the virtual objects manipulated by the offensive side can execute the finishing competitive actions/moves. The finishing competitive actions/moves include actions/moves such as shooting, layups, dunks, and others aimed at attacking the basket. After executing the finishing competitive actions/moves, the offensive side will temporarily cease their offense, for instance, transitioning from the offensive side to the defensive side.

Taking a football game as an example, the finishing zone refers to a zone within the virtual field area where the virtual objects of the offensive side can execute finishing competitive actions/moves. The finishing competitive actions/moves include actions/moves such as shooting.

The target finishing zone refers to a zone within the virtual field area where the virtual objects of the offensive side execute the finishing competitive actions/moves during this offensive play process.

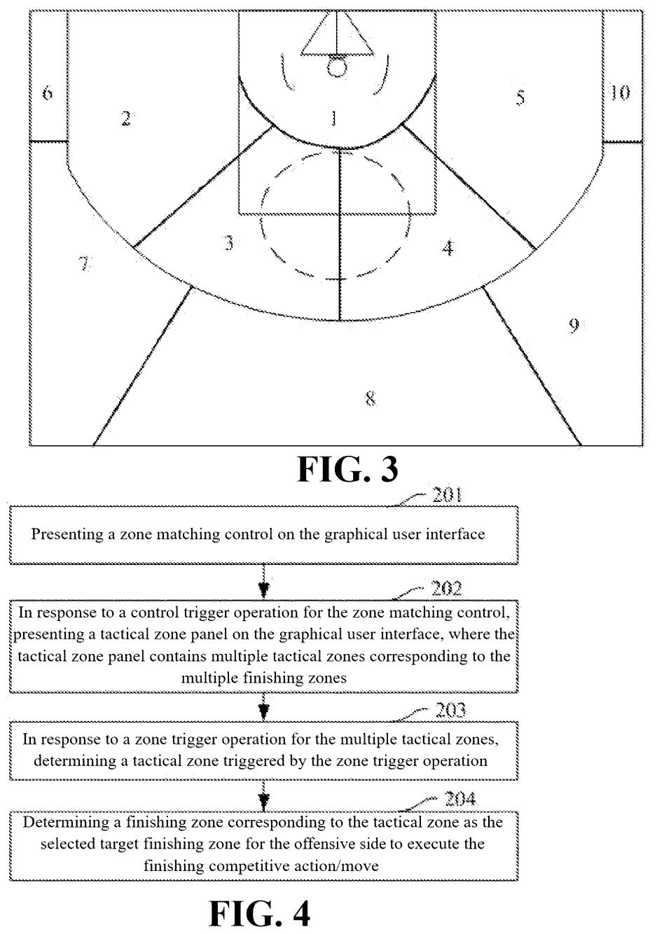

As shown in FIG. 3, it is a schematic diagram of a tactical zone panel in a basketball game. The tactical zone panel displays a tactical zone distribution map, where each tactical zone is in a one-to-one correspondence with a predefined finishing zone in the virtual field area. Specifically, in the virtual field area corresponding to the frontcourt of the basketball game, 10 finishing zones are predefined. Since the area where the offensive side executes the finishing competitive action/move during attack cannot encompass the entire virtual field area of the basketball match, in the embodiments of the present disclosure, the virtual field area of the frontcourt of the basketball game is taken as the corresponding virtual field area. There are 10 finishing zones in the virtual field area. The target finishing zone determined for this offensive play by the offensive side is any one of these 10 finishing zones, and these 10 finishing zones are in a one-to-one correspondence with the tactical zones in the tactical zone panel.

The determination of the target finishing zone can be achieved through selection. Correspondingly, it allows for the active selection/customization of the target finishing zone, which can be selected for executing the finishing competitive action. The determination of the target finishing zone can also be achieved through other methods, such as automatic determination.

In an embodiment, as shown in FIG. 4, the aforementioned step of determining, based on the virtual field area, a selected target finishing zone for the offensive side to execute a finishing competitive action includes Steps 201 to 204.

201: Presenting a zone matching control on the graphical user interface.

Presenting the zone matching control on the graphical user interface can be presenting the zone matching control in an overlaid manner on the virtual game screen. The zone matching control can be continuously presented in an overlaid manner on the virtual game screen, such as being continuously displayed in an overlaid manner on the virtual game screen after the virtual competitive sports game is launched. Alternatively, it can be presented in an overlaid manner on the virtual game screen through a trigger.

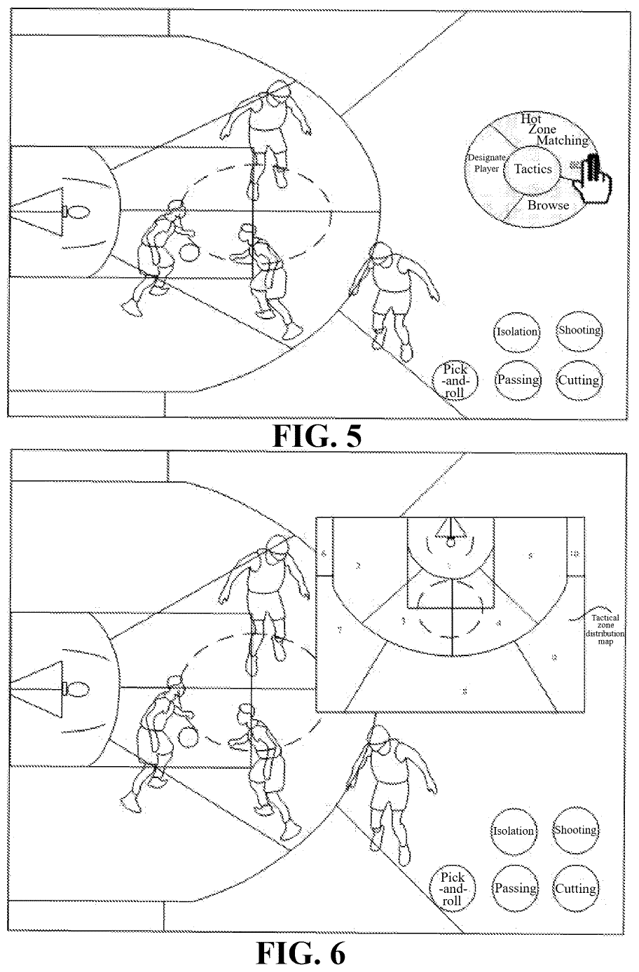

As shown in FIG. 5, it is a schematic diagram of a zone matching control displayed on the graphical user interface. In FIG. 5, the zone matching control is displayed in an overlaid manner on the virtual game screen through a trigger. For example, a tactic control is provided on the graphical user interface. In response to a control trigger operation for the tactic control, at least one auxiliary control is displayed on the periphery of the tactic control, where the auxiliary control includes the zone matching control. For example, on the right side of the virtual game screen corresponding to the graphical user interface, a tactic control, such as a “Tactics” control, is provided/displayed in an overlaid manner. In response to a control trigger operation for the tactic control, such as a long press on the tactic control (e.g., for more than 2 seconds), at least one auxiliary control corresponding to the tactic control is displayed on the graphical user interface. For instance, at least one auxiliary control is displayed on the periphery of the tactic control. The auxiliary controls include a browsing control (“Browse”), a zone matching control (“Hot Zone Matching”), a virtual object designation control (“Designate Player”), etc., thereby presenting the zone matching control in an overlaid manner on the virtual game screen. The functions of the browsing control and the zone matching control will be described later and are not explained here. The control trigger operation for the tactic control can also be other operations, which are not limited here.

202: In response to a control trigger operation for the zone matching control, presenting a tactical zone panel on the graphical user interface, where the tactical zone panel contains multiple tactical zones corresponding to the multiple finishing zones.

The control trigger operations for the zone matching control include, but are not limited to, click operations, touch operations, double-click operations, and swipe selection operations. For example, the virtual user manipulated by the holder user of the electronic device clicks, touches, double-clicks, or swipes to select the zone matching control on the graphical user interface. In response to the control trigger operation on the zone matching control, a tactical zone panel is presented on the graphical user interface. This tactical zone panel includes multiple tactical zones corresponding to multiple finishing zones. For instance, multiple tactical zones pre-determined in the virtual field area are presented in an overlaid manner on the virtual game screen.

Each tactical zone in these multiple tactical zones can be presented as corresponding controls in the form of text, graphics, etc., where one tactical zone corresponds to one control. Alternatively, the tactical zones can be presented in the form of a tactical zone distribution map, which includes multiple tactical zones.

As shown in FIG. 6, it is a schematic diagram of presenting a tactical zone distribution map of the virtual field area in an overlaid manner on the virtual game screen. Taking the virtual field area of a basketball game as an example, the tactical zone distribution map of the virtual field area includes 10 tactical zones, where these 10 tactical zones are in a one-to-one correspondence with 10 finishing zones in the virtual field area.

203: In response to a zone trigger operation for the multiple tactical zones, determining a tactical zone triggered by the zone trigger operation.

The zone trigger operation includes, but is not limited to, click operations, touch operations, double-click operations, swipe selection operations, etc. The virtual user manipulated by the holder user of the electronic device clicks, touches, double-clicks, or swipes to select one tactical zone from the multiple tactical zones on the graphical user interface. In response to the zone trigger operation for the multiple tactical zones, specifically, it can be in response to the zone trigger operation for a certain tactical zone among the multiple tactical zones, a tactical zone triggered by the zone trigger operation is determined. For instance, the tactical zone triggered by the zone trigger operation can be tactical zone 7 in FIG. 6.

204: Determining a finishing zone corresponding to the tactical zone as the selected target finishing zone for the offensive side to execute the finishing competitive action/move.

For example, tactical zone 7 in FIG. 6 corresponds to finishing zone 7 in the virtual field area. finishing zone 7, corresponding to tactical zone 7 in FIG. 3, is determined as the selected target finishing zone for the offensive side to execute the finishing competitive action/move.

In this embodiment, the invocation of tactical zones corresponding to multiple finishing zones in the virtual field area is enabled through the zone matching control, and the selected target finishing zone is determined based on the zone trigger operation on the tactical zones corresponding to the multiple finishing zones. In this embodiment, autonomous selection of the target finishing zone is achieved, allowing the user to select the target finishing zone according to their preferences, thereby improving the applicability and autonomy of virtual competitive sports games and enhancing the human-computer interaction efficiency.

In an embodiment, the aforementioned step of determining, based on the virtual field area, a selected target finishing zone for the offensive side to execute a finishing competitive action/move includes: in response to a field trigger operation for the virtual field area of the virtual game screen, determining a finishing zone associated with the field trigger operation; and determining the finishing zone as the selected target finishing zone for the offensive side to execute the finishing competitive action.

The field trigger operation can be a trigger operation distinct from all control trigger operations or all shortcut key operations involved in the virtual game scene of the virtual competitive sports game, in order to avoid conflicts. For example, the field trigger operation can be an operation of drawing a circle in the virtual field area of the virtual game screen. The virtual user corresponding to the holder user of the electronic device draws a circle in the virtual field area of the virtual game screen, which corresponds to the field trigger operation. In response to the field trigger operation, the finishing zone associated with the field trigger operation is determined. For instance, the finishing zone where the center point of the field trigger operation is located is determined, and this finishing zone is determined as the selected target finishing zone for the offensive side to execute the finishing competitive action.

In this embodiment, the selected target finishing zone is directly determined within the virtual field area of the virtual game screen, without using the method of invoking the zone matching control and triggering the zone matching control to determine the target finishing zone. This achieves autonomous selection and quick selection of the target finishing zone, allowing the user to select the target finishing zone according to their preferences, thereby improving the applicability and autonomy of virtual competitive sports games, while also improving the efficiency of determining the target finishing zone and enhancing the human-computer interaction efficiency.

103: Determining, from at least one virtual object manipulated by the offensive side, a target virtual object that matches the target finishing zone.

The offensive side includes at least one virtual object.

When the offensive side includes one virtual object, if the virtual object can execute the finishing competitive action in the target finishing zone, the virtual object is determined as the target virtual object matching the target finishing zone. In an embodiment, if the virtual object cannot execute the finishing competitive action in the target finishing zone or does not meet a preset offensive condition (e.g., the offensive attribute value is too low to meet the preset offensive condition, or the historical efficiency value for executing the target tactic is too low to meet the preset offensive condition, where the target tactic will be described later), the target virtual object is set to null, indicating that no matching target virtual object exists, and a corresponding prompt is given. If the virtual object can execute the finishing competitive action in the target finishing zone and meets the preset offensive condition, the virtual object is designated as the target virtual object matching the target finishing zone; or the virtual object that meets the preset offensive condition is directly designated as the target virtual object matching the target finishing zone. Alternatively, in some cases, when the offensive side includes one virtual object, the virtual object is directly designated as the target virtual object.

When there are multiple virtual objects, among the multiple virtual objects of the offensive side, if there exists no virtual object that can execute the finishing competitive action in the target finishing zone or no virtual object meeting the preset offensive condition, the target virtual object is set to null, indicating that no matching target virtual object exists, and a prompt is given; if there exists a virtual object that can execute the finishing competitive action in the target finishing zone and meets the preset offensive condition, that virtual object is designated as the target virtual object matching the target finishing zone; or the virtual object that meets the preset offensive condition is directly designated as the target virtual object matching the target finishing zone. If multiple target virtual objects are determined, one of them is designated as the final target virtual object.

The preset offensive condition may include having the highest offensive attribute value, having an offensive attribute value higher than a preset offensive attribute value, having the highest historical efficiency value for executing the target tactic, or having a historical efficiency value higher than a preset efficiency value. By selecting the target virtual object in the target finishing zone that meets the preset offensive condition, a better target virtual object can be selected to obtain better offensive opportunities, thereby improving the gaming experience and enhancing the human-computer interaction efficiency.

In an embodiment, the Step 103 includes: acquiring offensive attribute values of the multiple virtual objects manipulated by the offensive side in the target finishing zone, or historical efficiency values of the multiple virtual objects executing the target tactic in the target finishing zone; and determining a virtual object with the highest offensive attribute value or the highest historical efficiency value as the target virtual object.

The offensive attribute value of a virtual object may be the real-time offensive attribute value determined as the game progresses. This offensive attribute value can be automatically calculated as the game progresses or calculated based on multiple offensive attributes of the virtual object. Alternatively, the offensive attribute value can also be a fixed offensive attribute value determined before the current game, without specific limitations. The historical efficiency value can be the success rate or the number of successes when a virtual object executes the target tactic in the target finishing zone, such as the shooting success rate or the number of successful shots. A candidate virtual object among the virtual objects that has the highest offensive attribute value or the highest historical efficiency value is determined as the target virtual object.

After determining the target virtual object, the positional area corresponding to the target virtual object is marked on the graphical user interface. For example, the positional area beneath the feet of the target virtual object is marked with a circle.

The target virtual object in the target finishing zone that has the highest offensive attribute value or the highest historical efficiency value for executing the target tactic is automatically selected to obtain the best offensive opportunity, thereby improving the offensive success rate, enhancing the gaming experience, and enhancing the human-computer interaction efficiency.

104: Controlling the target virtual object to execute a preparatory action for the finishing competitive action, or controlling the target virtual object to execute the preparatory action for the finishing competitive action and to execute the finishing competitive action in the target finishing zone.

The preparatory action refers to one or more virtual competitive actions executed before the finishing competitive action. Only after executing the preparatory action can the finishing competitive action be executed. The preparatory actions include virtual competitive actions such as moving and transmitting virtual competitive objects. For example, the target virtual object moves from one finishing zone to the target finishing zone, transmits the virtual competitive object to another virtual object, or receives the virtual competitive object transmitted from other virtual objects.

For instance, in a basketball game, the target virtual object moves from a non-target finishing zone to the target finishing zone, or the target virtual object receives the basketball transmitted from another virtual object, for example, in a racing game, at least one action performed before the target virtual object drives the race car to the final sprint stop point.

For example, in a basketball game, executing the finishing competitive action in the target finishing zone includes controlling the target virtual object to execute a basket-attacking action/move in the target finishing zone. In a football game, it includes controlling the target virtual object to execute a shooting action/move in the target finishing zone. In a racing game, it includes controlling the target virtual object to execute the final racing sprint and stopping action/move in the target finishing zone.

If the target virtual object is controlled to only execute the preparatory action for the finishing competitive move, it is understood that the target virtual object cannot complete the finishing competitive action, but the target virtual object still needs to execute the preparatory action for the finishing competitive action. For example, in a basketball game, if the basketball is intercepted during the process of passing it to the target virtual object by other virtual objects, the target virtual object will be unable to complete the basket-attacking action/move in the target finishing zone. In a racing game, if the race car encounters a malfunction during the initial process of the target virtual object driving the race car to the race location or during the race before the target finishing zone, the target virtual object will be unable to complete the final racing sprint and stopping action/move in the target finishing zone.

In the above embodiment, the target finishing zone for executing the finishing competitive action can be selected, and the target virtual object in the target finishing zone that meets the preset offensive condition can be selected, and the target virtual object can be controlled to execute the preparatory action for the finishing competitive move, or the target virtual object can be controlled to execute the preparatory action and to execute the finishing competitive action in the target finishing zone. This enables autonomous selection of the target finishing zone while achieving the selection of a better target virtual object to determine better offensive opportunities. It improves the autonomy of the game, and improves the accuracy and efficiency of determining better offensive opportunities, thereby improving the gaming experience and enhancing the human-computer interaction efficiency.

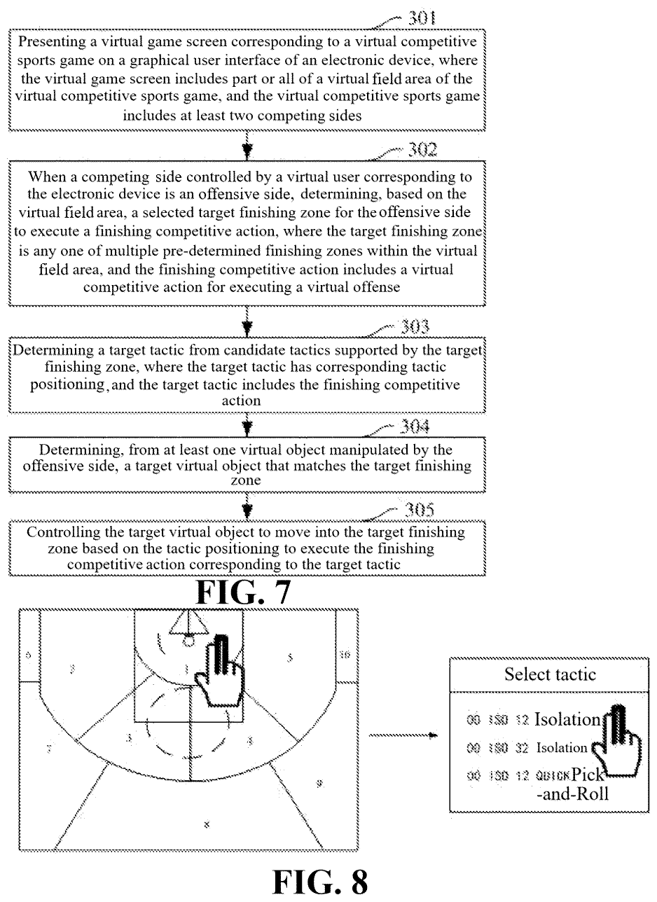

FIG. 7 is another schematic flowchart of a virtual game control method according to an embodiment of the present disclosure. The virtual game control method includes the following steps.

301: Presenting a virtual game screen corresponding to a virtual competitive sports game on a graphical user interface of an electronic device, where the virtual game screen includes part or all of a virtual field area of the virtual competitive sports game, and the virtual competitive sports game includes at least two competing sides.

302: When a competing side controlled by a virtual user corresponding to the electronic device is an offensive side, determining, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense.

303: Determining a target tactic from candidate tactics supported by the target finishing zone, where the target tactic has corresponding tactic positioning, and the target tactic includes the finishing competitive action.

In some virtual competitive sports games, the tactics involved in the virtual competitive sports games are pre-configured. Taking a basketball game as an example, the tactics involved include isolation, shooting, passing, cutting, pick-and-roll, three-point, and others.

The tactics involved include the tactic positioning and process of at least one or more virtual objects of the offensive side, as well as the execution of finishing competitive action within the tactics. The tactic positioning refer to the tactic positioning corresponding to at least one or more virtual objects of the offensive side during offense in the corresponding tactic. In a basketball game, the offensive action/move toward the basket can be completed by a single virtual object or with the assistance of multiple virtual objects. In this tactic, one or more virtual objects do not remain stationary to complete the action/move of attacking the basket. Instead, each virtual object has corresponding tactic positioning, such as moving/running along an arc trajectory within a certain area to obtain an offensive opportunity to attack the basket.

In virtual competitive sports games, a certain zone or multiple zones in the virtual field area are pre-configured as finishing zones, and the tactics supported by/corresponding to the zones are also configured.

After the target finishing zone is determined, if the target finishing zone matches a pre-configured finishing zone and the tactic library is also configured with a tactic supported by/corresponding to the finishing zone, the tactic is designated as the candidate tactic supported by/corresponding to the target finishing zone, and one tactic is determined from the candidate tactics as the target tactic. If the target finishing zone does not match the pre-configured finishing zone, it means that the finishing zone does not belong to the target finishing zone, and a prompt will be given. If the target finishing zone matches the pre-configured finishing zone, but the tactic library is not configured with a tactic supported by/corresponding to the finishing zone, it means that the target finishing zone has no target tactics, and a prompt will be given.

After determining the candidate tactic supported by the target finishing zone, the target tactic supported by the target finishing zone can be determined in any manner, such as automatically determining a target tactic.

In an embodiment, the aforementioned step of determining a target tactic from candidate tactics supported by the target finishing zone includes: presenting at least one candidate tactic supported by the target finishing zone on the graphical user interface; and in response to a tactical selection operation for the at least one candidate tactic, determining the target tactic from the at least one candidate tactic. In this embodiment, a target tactic is selected through a tactical selection operation on the graphical user interface by a virtual user manipulated by the holder user of the electronic device. This enables active selection of the target tactic, allowing the specified tactic positioning and process to be executed according to the designated target tactic, thereby improving the autonomy of the game, enhancing the user experience, and increasing the human-computer interaction efficiency.

The tactical selection operation includes, but is not limited to, a click operation, a touch operation, a double-click operation, etc. For example, a virtual user manipulated by the holder user of the electronic device clicks, touches, or double-clicks one of the presented at least one candidate tactics on the graphical user interface. In response to the tactical selection operation for the at least one candidate tactic, the target tactic is determined on the graphical user interface.

As shown in FIG. 8, it is a schematic diagram of candidate tactics supported by a certain target finishing zone displayed on the graphical user interface. If Finishing Zone 1 in the virtual field area is determined as the target finishing zone, the candidate tactics supported by Finishing Zone 1 are presented on the graphical user interface, including: “00 ISO 12 Isolation”, “00 ISO 32 Isolation”, “00 ISO 12 QUICK Pick-and-Roll”, etc. After the virtual user manipulated by the holder user of the electronic device clicks on “00 ISO 12 Isolation”, “00 ISO 12 Isolation” is determined as the target tactic for Finishing Zone 1 in this offensive play. Here, “00 ISO 12”,“00 ISO 32”, etc., are the corresponding tactic types. In addition, the tactic library not only stores tactics but also stores the corresponding tactic types.

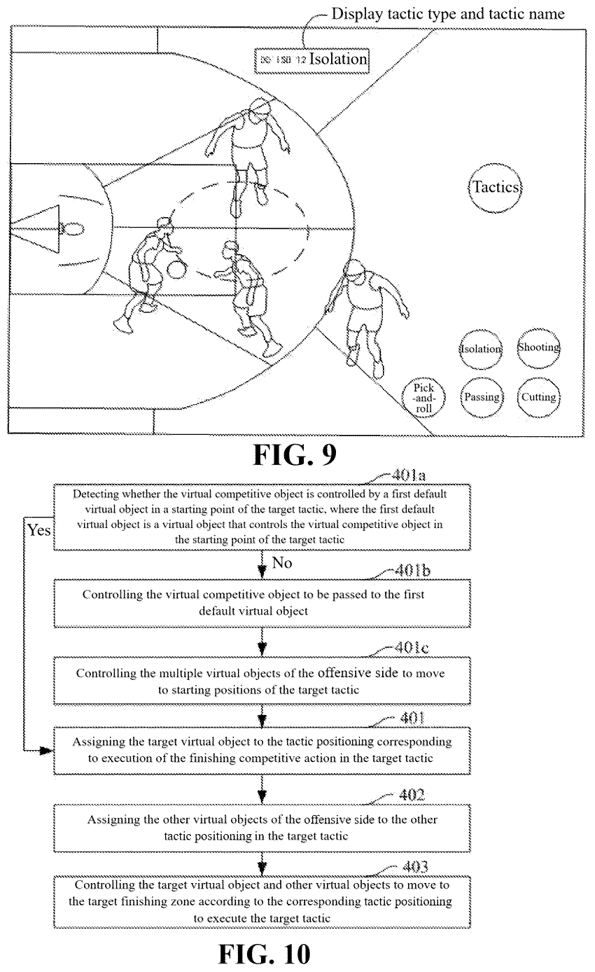

In an embodiment, after a target tactic is selected, the tactic type and/or tactic name of the target tactic is displayed in the virtual game screen. As shown in FIG. 9.

304: Determining, from at least one virtual object manipulated by the offensive side, a target virtual object that matches the target finishing zone.

For Step 304, reference can be made to the description of the corresponding step mentioned above. For the steps in this embodiment that are not described in detail, please refer to the description of the corresponding steps mentioned above, which will not be repeated here.

305: Controlling the target virtual object to move into the target finishing zone based on the tactic positioning to execute the finishing competitive action corresponding to the target tactic.

After determining the target virtual object, the target virtual object is controlled to move into the target finishing zone based on the tactic positioning to execute the finishing competitive action of the target tactic.

If the target tactic includes the tactic positioning of a single virtual object of the offensive side, the target virtual object moves into the target finishing zone according to the tactic positioning to execute the finishing competitive action of the target tactic.

If the target tactic includes the tactic positioning of multiple virtual objects of the offensive side, as shown in FIG. 10, the aforementioned Step 305 includes the following Steps 401 to 403.

401: Assigning the target virtual object to the tactic positioning corresponding to execution of the finishing competitive action in the target tactic.

The tactic includes tactic positioning of multiple virtual objects of the offensive side.

If the virtual objects corresponding to the tactic positioning in the target tactic are not preset but are determined in real time during the execution of this offensive play, the target virtual object is directly designated as the virtual object executing the finishing competitive action in the target tactic. Correspondingly, the target virtual object is assigned to the tactic positioning corresponding to the virtual object executing the finishing competitive action in the target tactic.

If the virtual objects corresponding to the tactic positioning in the target tactic are preset during the design of the tactic, each virtual object executes the virtual competitive actions/virtual competitive moves of the entire tactic according to the corresponding tactic positioning during actual execution. In the embodiments of the present disclosure, a virtual object meeting the preset offensive condition in the target finishing zone is designated as the target virtual object. However, the determined target virtual object may not necessarily be the originally designated virtual object in the target tactic for executing the finishing competitive action.

Regardless of whether the determined target virtual object is the originally designated virtual object in the target tactic for executing the finishing competitive action, it is necessary to obtain a second default virtual object in the target tactic. This second default virtual object is the originally designated virtual object in the target tactic for executing the finishing competitive action. The second default virtual object possesses the target virtual role identity, meaning that the target tactic specifies that the second default virtual object with the target virtual role identity is to execute the finishing competitive action.

When the virtual role identity of the target virtual object matches the target virtual role identity, the target virtual object is assigned to the tactic positioning corresponding to the execution of the finishing competitive action. If the virtual role identity of the target virtual object does not match the target virtual role identity, tactic positioning of the target virtual object is replaced with tactic positioning of the second default virtual object.

For example, in a basketball game, the virtual role identities originally set for the virtual objects in the target tactic include small forward, power forward, center, shooting guard, and point guard. Their corresponding tactic positioning include the tactic positioning for the small forward, the tactic positioning for the power forward, the tactic positioning for the center, the tactic positioning for the shooting guard, and the tactic positioning for the point guard, respectively. If the target virtual role identity of the second default virtual object is a small forward, when it is determined that the virtual role identity of the target virtual object is a power forward, the virtual role identity of the target virtual object does not match the target virtual role identity of the second default virtual object. In this case, the tactic positioning corresponding to the small forward is designated as the tactic positioning of the power forward, and the power forward is assigned to the tactic positioning originally corresponding to the small forward, thereby replacing the tactic positioning of the target virtual object with that of the second default virtual object. If the target virtual role identity of the second default virtual object is a small forward, when it is determined that the virtual role identity of the target virtual object is a small forward, the virtual role identity of the target virtual object matches the target virtual role identity of the second default virtual object. In this case, the target virtual object is assigned to the tactic positioning corresponding to the execution of the finishing competitive action.

It should be noted that small forward, power forward, center, shooting guard, and point guard are the virtual role identities of the virtual objects in the tactic. Examples in the subsequent text will also be illustrated using virtual role identities for better understanding.

402: Assigning the other virtual objects of the offensive side to the other tactic positioning in the target tactic.

If the virtual objects corresponding to the tactic positioning in the target tactic are determined in real time during the execution of this offensive play, the tactic positioning corresponding to other virtual objects of the offensive side is determined according to preset rules. Taking a basketball game as an example, if the virtual role identity of the target virtual object is currently a small forward, its corresponding tactic positioning is the tactic positioning corresponding to the small forward. Other virtual objects can be assigned randomly or according to certain rules, such as based on the priority order of the virtual role identities corresponding to the other virtual objects.

If the virtual objects corresponding to the tactic positioning in the target tactic have already been pre-determined during the design of the tactic, after the tactic positioning of the virtual role identity of the target virtual object is replaced with the tactic positioning of the target virtual role identity of the second default virtual object, one or more of the other virtual objects in the target tactic may also change simultaneously.

In a scenario, the above Step 402 includes: if the virtual role identity of the target virtual object does not match the target virtual role identity, keeping tactic positioning corresponding to remaining virtual objects of the offensive side, except for the second default virtual object and the target virtual object, unchanged; or assigning the remaining virtual objects of the offensive side to corresponding tactic positioning in the target tactic according to a priority order of virtual role identities of the remaining virtual objects in the virtual competitive sports game.

For example, after assigning the power forward to the tactic positioning originally corresponding to the small forward, the small forward is correspondingly assigned to the tactic positioning originally corresponding to the power forward. The tactic positioning corresponding to the other virtual objects, such as the center, the point guard, and the shooting guard, remains unchanged. That is, the tactic positioning originally corresponding to the center, the tactic positioning originally corresponding to the point guard, and the tactic positioning originally corresponding to the point forward guard all remain unchanged.

For instance, the virtual role identities refer to small forward, power forward, center, shooting guard, and point guard as mentioned above. Assuming that the priority order of the virtual role identities is center, power forward, small forward, shooting guard, and point guard. If the target virtual role identity of the second default virtual object in the target tactic is a small forward, while the determined virtual role identity of the target virtual object is a power forward, the power forward is assigned to the tactic positioning originally corresponding to the small forward. According to the priority order of virtual role identities, the center still corresponds to the tactic positioning of the center. Since the tactic positioning originally belonging to the small forward has been assigned to the power forward, the small forward can only be assigned to the tactic positioning corresponding to the power forward. As the original tactic positioning of the shooting guard and the point guard has not been occupied, they are accordingly assigned.

For another example, if the default target virtual object in the target tactic is a small forward, while the determined target virtual object is a center, the center is assigned to the tactic positioning originally corresponding to the small forward, the power forward is assigned to the tactic positioning originally corresponding to the center, the small forward is assigned to the tactic positioning originally corresponding to the power forward, the shooting guard is assigned to the tactic positioning originally corresponding to the shooting guard, and the point guard is assigned to the tactic positioning originally corresponding to the point guard.

In a scenario, the above Step 402 includes: if the virtual role identity of the target virtual object matches the target virtual role identity, keeping tactic positioning corresponding to the other virtual objects of the offensive side, except for the target virtual object unchanged; or assigning the other virtual objects of the offensive side to the other tactic positioning in the target tactic according to a priority order of virtual role identities of the other virtual objects in the virtual competitive sports game.

For example, if the target virtual role identity of the second default virtual object is a small forward, when it is determined that the virtual role identity of the target virtual object is a small forward, the virtual role identity of the target virtual object matches the target virtual role identity of the second default virtual object. In this case, the virtual role identity of the target virtual object, small forward, is assigned to the tactic positioning of the target virtual role identity, and the tactic positioning corresponding to the others, such as the center, the power forward, the point guard, and the shooting guard, remain unchanged; or for the others, including the center, the power forward, the point guard, and the shooting guard, the tactic positioning is assigned according to the priority order of virtual role identities: center, power forward, small forward, shooting guard, and point guard.

403: Controlling the target virtual object and other virtual objects to move to the target finishing zone according to the corresponding tactic positioning to execute the target tactic.

The target virtual object is controlled to execute the target tactic based on its tactic positioning, while the other virtual objects are controlled to execute the target tactic based on their respective tactic positioning, enabling the target virtual object to execute the finishing competitive action.

In an embodiment, when the target tactic has been selected, it is possible that the virtual game screen does not immediately allow for the execution of the target tactic. Accordingly, as shown in FIG. 10, the aforementioned Step 305 further includes the following Steps 401a to 401c.

401a: Detecting whether the virtual competitive object is controlled by a first default virtual object in a starting point of the target tactic, where the first default virtual object is a virtual object that controls the virtual competitive object in the starting point of the target tactic.

In the multiple tactics preset in the tactic library, each tactic has a starting point with a first default virtual object, where this first default virtual object is a virtual object that controls the virtual competitive object in the starting point of the tactic. For example, in a certain tactic of a basketball game, the starting point has a first default virtual object that controls the basketball.

However, since the target tactic is selected and determined, it may not always be the right moment to execute that target tactic when its execution is attempted. For instance, the virtual competitive object on the field may not be controlled by the first default virtual object in the starting point of the target tactic. That is, the basketball may not be in the hands of the first default virtual object. Therefore, it is necessary to detect whether the virtual object currently controlling the virtual competitive object in the virtual game screen is the first default virtual object in the starting point of the target tactic.

If yes, the process proceeds to Step 401; if not, the process proceeds to Step 401b.

401b: Controlling the virtual competitive object to be passed to the first default virtual object.

For example, in a basketball game, a passing tactic is executed to pass the virtual competitive object from the currently controlled virtual object to the first default virtual object. Alternatively, other control methods capable of passing the virtual competitive object to the first default virtual object can also be executed to implement the corresponding function.

401c: Controlling the multiple virtual objects of the offensive side to move to starting positions of the target tactic.

For instance, five players in a basketball game are controlled to run to the starting positions of the target tactic respectively, in order to begin executing the target tactic.

The execution order of Steps 401b and 401c can be parallel, or sequential, or Step 401b can be executed during the execution of Step 401c, and so on.

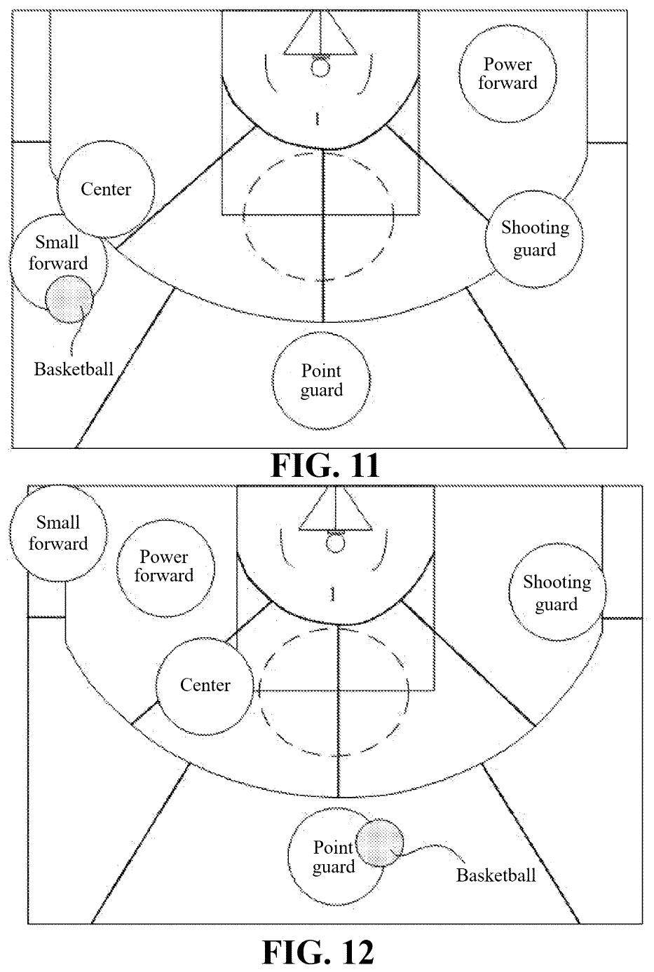

For example, in the starting point of the target tactic, the starting positions of the players are as shown in FIG. 11. The determined virtual role identity of the target virtual object is a small forward, who is located in Finishing Zone 7, with the basketball in the hands of the small forward, executing a basket-attacking move in Finishing Zone 7. However, the current positions of the players are as shown in FIG. 12, with the basketball in the hands of the point guard. Therefore, in the state of FIG. 12, it is necessary to execute other tactics or other virtual competitive actions/competitive moves to achieve the state corresponding to FIG. 11. Once the state shown in FIG. 11 is achieved, the multiple virtual objects then execute the target tactic according to their corresponding tactic positioning.

In the above embodiment, a completely new approach is employed to determine better offensive opportunities in virtual competitive sports games, improving the accuracy and efficiency of determining better offensive opportunities, enhancing the gaming experience, and increasing the human-computer interaction efficiency. In the embodiments of the present disclosure, better offensive opportunities are obtained using the autonomously selected target finishing zone and the target virtual object with the highest offensive attribute value and through tactic positioning and moves/actions of the tactic itself, thereby enriching the tactical level strategy in virtual competitive sports games and improving the human-computer interaction efficiency.

In an embodiment, when the competing side controlled by the virtual user corresponding to the electronic device is the offensive side, the virtual game control method further includes the steps of: providing a tactic control on the graphical user interface; in response to a control trigger operation for the tactic control, displaying at least one auxiliary control on the periphery of the tactic control, where the auxiliary control includes a tactic browsing control; in response to a control trigger operation for the tactic browsing control, presenting a tactical panel on the graphical user interface, where the tactical panel includes at least one tactic of the offensive side; in response to a tactic selection operation for the at least one tactic, determining the target tactic from the at least one tactic; and controlling the at least one virtual object manipulated by the offensive side to execute the target tactic.

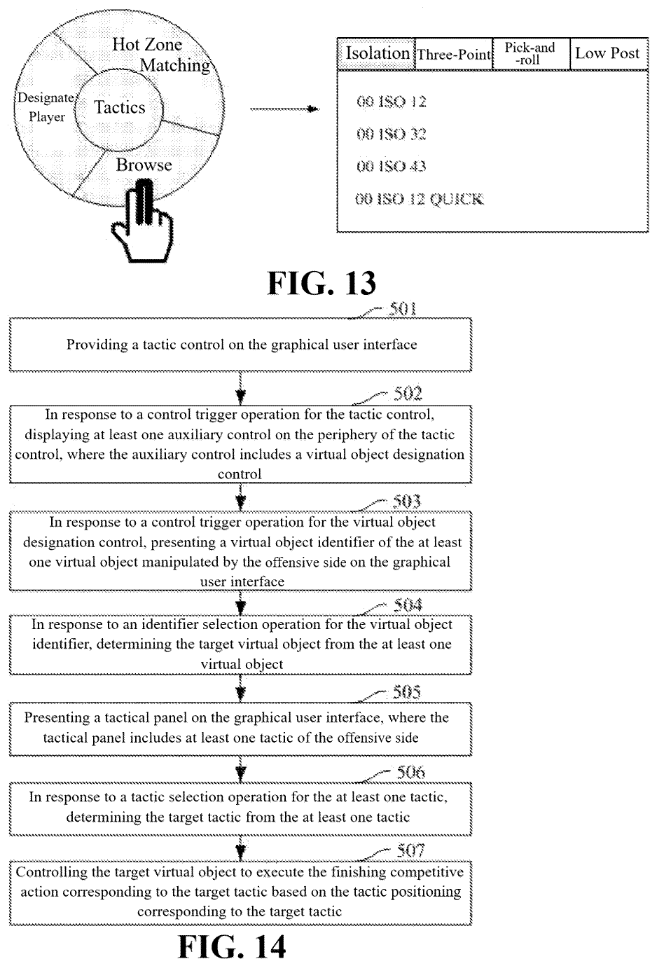

The tactic control on the graphical user interface is as shown in FIG. 9 and is displayed as “Tactics”. The tactic control is permanently displayed in the virtual game screen. For the control trigger operation of the tactic control, reference can be made to the corresponding process described above. At least one auxiliary control is displayed on the periphery of/surrounding the tactic control, where the auxiliary control includes a tactic browsing control, which is displayed as “Browse”, as shown in FIG. 5 or FIG. 13.

The tactical panel presented on the graphical user interface is as shown in FIG. 13. The tactical panel includes at least one tactic of the offensive side and displays all tactics of the offensive side. As shown in FIG. 13, the tactical panel includes multiple different tactic labels, such as “Isolation”, “Three-Point”, “Pick-and-Roll”, and “Low Post”. Each different tactic label includes at least one tactic. For example, the “Isolation” tactic label includes “00 ISO 12”, “00 ISO 32”, “00 ISO 43”, and “00 ISO 12 QUICK”.

In response to a label trigger operation for the at least one tactic label, the target tactic label corresponding to the label trigger operation is determined, and at least one tactic in the target tactic label is displayed. In response to a tactic selection operation for the at least one tactic, a target tactic is determined from the at least one tactic in the target tactic label. For example, in response to a label trigger operation for the at least one tactic label, the target tactic label is determined to be the “Isolation” tactic label. In response to a tactic selection operation for the at least one tactic in the “Isolation” tactic label, and a target tactic is determined from the at least one tactic in the “Isolation” tactic label. For instance, the target tactic is “00 ISO 12”.

After the target tactic is determined, the at least one virtual object manipulated by the offensive side is controlled to execute the target tactic. In a basketball game, there are five virtual objects manipulated by the offensive side, where the five virtual objects are controlled to execute the target tactic.

In an embodiment, the step of controlling the at least one virtual object manipulated by the offensive side to execute the target tactic includes: detecting whether the virtual competitive object is controlled by a first default virtual object in a starting point of the target tactic, where the first default virtual object is a virtual object that controls the virtual competitive object in the starting point of the target tactic; if not, controlling the virtual competitive object to be passed to the first default virtual object, and controlling the multiple virtual objects of the offensive side to move to starting positions of the target tactic; next, controlling the multiple virtual objects of the offensive side to execute the target tactic according to the tactic positioning corresponding to the target tactic, or if the virtual competitive object is controlled by the first default virtual object in the starting point of the target tactic, executing the step of controlling the multiple virtual objects of the offensive side to execute the target tactic according to the tactic positioning corresponding to the target tactic.

In this case, the multiple virtual objects of the offensive side respectively execute the target tactic according to the tactic positioning corresponding to the multiple virtual role identities in the target tactic. For example, the small forward executes the target tactic according to the tactic positioning corresponding to the virtual role identity of the small forward in the target tactic, the center executes the target tactic according to the tactic positioning corresponding to the virtual role identity of the center in the target tactic, and so on, with the multiple virtual objects working together to execute the target tactic.

FIG. 14 is a schematic flowchart of a virtual game control method according to an embodiment of the present disclosure. The virtual game control method includes the following steps.

501: Providing a tactic control on the graphical user interface.

The tactic control, as shown in FIG. 9, is displayed as “Tactics”.

502: In response to a control trigger operation for the tactic control, displaying at least one auxiliary control on the periphery of the tactic control, where the auxiliary control includes a virtual object designation control.

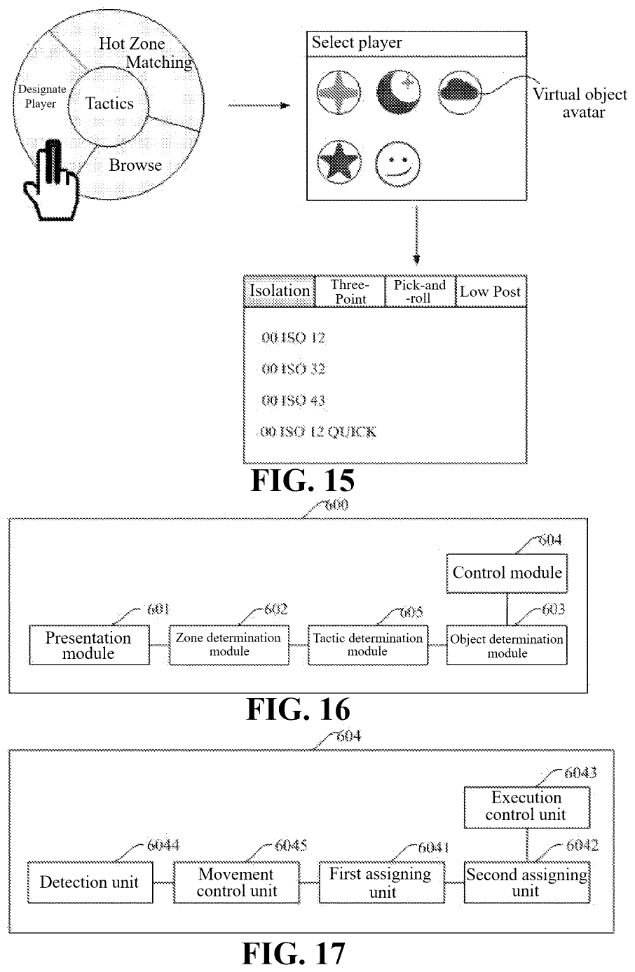

For the control trigger operation of the tactic control, reference can be made to the corresponding process described above. At least one auxiliary control is displayed on the periphery of/surrounding the tactic control, where this auxiliary control includes a virtual object designation control, which is displayed as “Designate Player,” as shown in FIG. 5 or FIG. 15.

503: In response to a control trigger operation for the virtual object designation control, presenting a virtual object identifier of the at least one virtual object manipulated by the offensive side on the graphical user interface.

The virtual object identifier may be the virtual object username and/or virtual object avatar. For explanation purposes, the virtual object avatar is used as an example. For a basketball game, the offensive side manipulates five virtual objects. The presented virtual object identifiers, as shown in FIG. 15, include five different virtual object identifiers.

504: In response to an identifier selection operation for the virtual object identifier, determining the target virtual object from the at least one virtual object.

In response to an identifier selection operation for the virtual object identifier, a target virtual object identifier is determined from the virtual object identifier; and a virtual object corresponding to the target virtual object identifier is determined as the target virtual object. The identifier selection operation includes, but is not limited to, a click operation, a touch operation, a double-click operation, etc.

505: Presenting a tactical panel on the graphical user interface, where the tactical panel includes at least one tactic of the offensive side.

The tactical panel includes at least one tactic of the offensive side and displays all tactics of the offensive side.

506: In response to a tactic selection operation for the at least one tactic, determining the target tactic from the at least one tactic.

In response to a label trigger operation for the at least one tactic label, the target tactic label corresponding to the label trigger operation is determined, and at least one tactic in the target tactic label is displayed. In response to a tactic selection operation for the at least one tactic, a target tactic is determined from the at least one tactic in the target tactic label.

507: Controlling the target virtual object to execute the finishing competitive action corresponding to the target tactic based on the tactic positioning corresponding to the target tactic.

In an embodiment, Step 507 includes: assigning the target virtual object to the tactic positioning corresponding to execution of the finishing competitive action in the target tactic; assigning the other virtual objects of the offensive side to the other tactic positioning in the target tactic; and controlling the target virtual object and the other virtual objects to execute the target tactic according to the corresponding tactic positioning.

In an embodiment, the virtual competitive sports game further includes a virtual competitive object, and the virtual game control method further includes: detecting whether the virtual competitive object is controlled by a first default virtual object in a starting point of the target tactic, where the first default virtual object is a virtual object that controls the virtual competitive object in the starting point of the target tactic; if not, controlling the virtual competitive object to be passed to the first default virtual object; and controlling the multiple virtual objects of the offensive side to move to starting positions of the target tactic; and then proceeding to the step of assigning the target virtual object to the tactic positioning corresponding to execution of the finishing competitive action in the target tactic.

All of the above technical solutions can be arbitrarily combined to form optional embodiments of the present disclosure, which will not be repeated here.

It should be noted that the number of participants in the basketball game shown in the accompanying drawings of the embodiments of the present disclosure does not limit the number of participants in a basketball game. Generally, the competing sides participating in the basketball game include the offensive side and the defensive side, and the number of players on both sides is generally 5. Correspondingly, only a portion of the participants in the basketball game are shown in the accompanying drawings of the specification.

To better implement the virtual game control method of the embodiments of the present disclosure, the present disclosure further provides a virtual game control apparatus. Please refer to FIG. 16. FIG. 16 is a structural schematic diagram of a virtual game control apparatus according to an embodiment of the present disclosure. The virtual game control apparatus 600 may include a presentation module 601, a zone determination module 602, an object determination module 603, and a control module 604.

The presentation module 601 is configured to: present a virtual game screen corresponding to a virtual competitive sports game on a graphical user interface of an electronic device, where the virtual game screen includes part or all of a virtual field area of the virtual competitive sports game, and the virtual competitive sports game includes at least two competing sides.

The zone determination module 602 is configured to: when a competing side controlled by a virtual user corresponding to the electronic device is an offensive side, determine, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense.

The object determination module 603 is configured to: determine, from at least one virtual object manipulated by the offensive side, a target virtual object that matches the target finishing zone.

The control module 604 is configured to: control the target virtual object to execute a preparatory action for the finishing competitive action, or control the target virtual object to execute the preparatory action and to execute the finishing competitive action in the target finishing zone.

In an embodiment, as shown in FIG. 16, the virtual game control apparatus 600 further includes a tactic determination module 605. Correspondingly, the tactic determination module 605 is configured to: determine a target tactic from candidate tactics supported by the target finishing zone, where the target tactic has corresponding tactic positioning, and the target tactic includes the finishing competitive action. Correspondingly, the control module 604 is specifically configured to: control the target virtual object to move into the target finishing zone based on the tactic positioning to execute the finishing competitive action corresponding to the target tactic.

In the above embodiment, the offensive side includes multiple virtual objects, and the target tactic further includes tactic positioning of the multiple virtual objects of the offensive side. The control module 604, as shown in FIG. 17, specifically includes a first assigning unit 6041, a second assigning unit 6042, and an execution control unit 6043. The first assigning unit 6041 is configured to: assign the target virtual object to the tactic positioning corresponding to execution of the finishing competitive action in the target tactic. The second assigning unit 6042 is configured to: assign the other virtual objects of the offensive side to the other tactic positioning in the target tactic. The execution control unit 6043 is configured to: control the target virtual object and the other virtual objects to execute the target tactic according to the corresponding tactic positioning.

In an embodiment, the control module 604 further includes a detection unit 6044 and a movement control unit 6045. The detection unit 6044 is configured to: detect whether the virtual competitive object is controlled by a first default virtual object in a starting point of the target tactic, where the first default virtual object is a virtual object that controls the virtual competitive object in the starting point of the target tactic. Correspondingly, the movement control unit 6045 is configured to: if the virtual competitive object is not controlled by the first default virtual object in the starting point of the target tactic, control the virtual competitive object to be passed to the first default virtual object; and control the multiple virtual objects of the offensive side to move to starting positions of the target tactic.

In an embodiment, the first assigning unit 6041 is specifically configured to: acquire a second default virtual object in the target tactic, where the target tactic specifies that the finishing competitive action is to be executed by the second default virtual object with a target virtual role identity; and if a virtual role identity of the target virtual object matches the target virtual role identity, assign the target virtual object to the tactic positioning corresponding to execution of the finishing competitive action; or if the virtual role identity of the target virtual object does not match the target virtual role identity, replace tactic positioning of the target virtual object with tactic positioning of the second default virtual object.

In an embodiment, the second assigning unit 6042 is specifically configured to: if the virtual role identity of the target virtual object does not match the target virtual role identity, keep tactic positioning corresponding to remaining virtual objects of the offensive side, except for the second default virtual object and the target virtual object, unchanged; or assign the remaining virtual objects of the offensive side to corresponding tactic positioning in the target tactic according to a priority order of virtual role identities of the remaining virtual objects in the virtual competitive sports game; or if the virtual role identity of the target virtual object matches the target virtual role identity, keep tactic positioning corresponding to the other virtual objects of the offensive side, except for the target virtual object unchanged; or assign the other virtual objects of the offensive side to the other tactic positioning in the target tactic according to a priority order of virtual role identities of the other virtual objects in the virtual competitive sports game.

In an embodiment, the tactic determination module 605, when executing the step of determining a target tactic from candidate tactics supported by the target finishing zone, specifically executes: displaying at least one candidate tactic supported by the target finishing zone on the graphical user interface; and in response to a tactic selection operation for the at least one candidate tactic, determining the target tactic from the at least one candidate tactic.

In an embodiment, the zone determination module 602 is specifically configured to: present a zone matching control on the graphical user interface;
in response to a control trigger operation for the zone matching control, present a tactical zone panel on the graphical user interface, where the tactical zone panel contains multiple tactical zones corresponding to the multiple finishing zones; and in response to a zone trigger operation for the multiple tactical zones, determine a finishing zone corresponding to a tactical zone triggered by the zone trigger operation as the selected target finishing zone for the offensive side to execute the finishing competitive action.

In an embodiment, the zone determination module 602 is specifically configured to: provide a tactic control on the graphical user interface; and in response to a control trigger operation for the tactic control, display at least one auxiliary control on the periphery of the tactic control, where the auxiliary control includes the zone matching control.

In an embodiment, the auxiliary control of the tactic control further includes a tactic browsing control. Correspondingly, the tactic determination module 605 is further configured to: in response to a control trigger operation for the tactic browsing control, present a tactical panel on the graphical user interface, where the tactical panel includes at least one tactic of the offensive side; and in response to a tactic selection operation for the at least one tactic, determine the target tactic from the at least one tactic. Correspondingly, the control module 604 is further configured to: control the at least one virtual object manipulated by the offensive side to execute the target tactic.

In an embodiment, the auxiliary control of the tactic control further includes a virtual object designation control. Correspondingly, the object determination module 603 is further configured to: in response to a control trigger operation for the virtual object designation control, present a virtual object identifier of the at least one virtual object manipulated by the offensive side on the graphical user interface; and in response to an identifier selection operation for the virtual object identifier, determine the target virtual object from the at least one virtual object. The tactic determination module 605 is further configured to: present a tactical panel on the graphical user interface, where the tactical panel includes at least one tactic of the offensive side; and in response to a tactic selection operation for the at least one tactic, determine the target tactic from the at least one tactic. Correspondingly, the control module 604 is further configured to: control the target virtual object to execute the finishing competitive action corresponding to the target tactic based on the tactic positioning corresponding to the target tactic.

In an embodiment, the offensive side includes multiple virtual objects, and the object determination module 603 is specifically configured to: acquire an offensive attribute value of the virtual object in the target finishing zone, or a historical efficiency value of the virtual object executing a target tactic in the target finishing zone; and determine a virtual object with the highest offensive attribute value or the highest historical efficiency value as the target virtual object.

It should be noted that the acquisition of the virtual object identifier, the acquisition of the offensive attribute value of the virtual object in the target finishing zone, the acquisition of the historical efficiency value, and the acquisition of the virtual role identity of the virtual object mentioned above are all performed under the condition that user authorization has been obtained.

All of the above technical solutions can be arbitrarily combined to form optional embodiments of the present disclosure, which will not be repeated here.

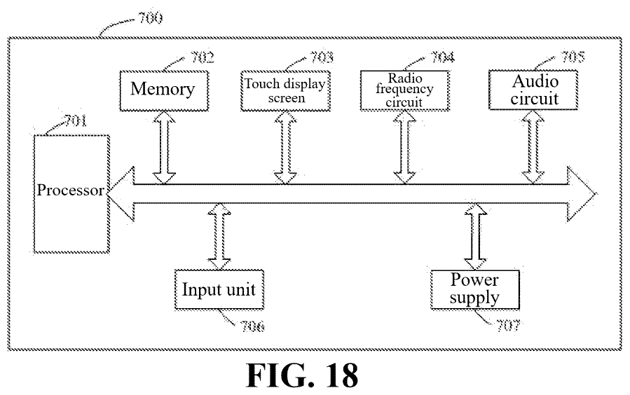

Accordingly, the embodiments of the present disclosure further provide an electronic device. The electronic device may be an electronic device or a server. As shown in FIG. 18. FIG. 18 is a structural schematic diagram of an electronic device according to an embodiment of the present disclosure. The electronic device 700 includes a processor 701 with one or more processing cores, a memory 702 with one or more computer-readable storage media, and a computer program stored on the memory 702 and runnable on the processor. The processor 701 is electrically connected to the memory 702. It should be understood by those skilled in the art that the structure of the electronic device shown in the figure does not limit the electronic device. The device may include more or fewer components than shown, combine certain components, or adopt a different component arrangement.

The processor 701 is the control center of the electronic device 700, connecting various parts of the electronic device 700 through various interfaces and circuits. By executing or loading software programs (computer programs) and/or modules stored in the memory 702, and invoking data stored in the memory 702, the processor executes various functions of the electronic device 700 and processes data, thereby providing overall monitoring of the electronic device 700.

In the embodiment of the present disclosure, the processor 701 in the electronic device 700 will load instructions corresponding to the processes of one or more application programs into the memory 702 according to the following steps, and the processor 701 will run the application programs stored in the memory 702 to achieve various functions:
presenting a virtual game screen corresponding to a virtual competitive sports game on a graphical user interface of an electronic device, where the virtual game screen includes part or all of a virtual field area of the virtual competitive sports game, and the virtual competitive sports game includes at least two competing sides; when a competing side controlled by a virtual user corresponding to the electronic device is an offensive side, determining, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense; determining, from at least one virtual object manipulated by the offensive side, a target virtual object that matches the target finishing zone; and controlling the target virtual object to execute a preparatory action for the finishing competitive action, or controlling the target virtual object to execute the preparatory action and to execute the finishing competitive action in the target finishing zone.

In an embodiment, the processor 701 further executes: determining a target tactic from candidate tactics supported by the target finishing zone, where the target tactic has corresponding tactic positioning, and the target tactic includes the finishing competitive action. Correspondingly, the processor 701, when executing the step of controlling the target virtual object to execute the preparatory action and to execute the finishing competitive action in the target finishing zone, specifically executes: controlling the target virtual object to move into the target finishing zone based on the tactic positioning to execute the finishing competitive action corresponding to the target tactic.

In an embodiment, the offensive side includes multiple virtual objects, the target tactic further includes tactic positioning of the multiple virtual objects of the offensive side, and the processor 701, when executing the step of controlling the target virtual object to move into the target finishing zone based on the tactic positioning to execute the finishing competitive action corresponding to the target tactic, specifically executes: assigning the target virtual object to the tactic positioning corresponding to the virtual object executing the finishing competitive action in the target tactic; assigning the other virtual objects of the offensive side to the other corresponding tactic positioning in the target tactic; and controlling the target virtual object and the other virtual objects to execute the target tactic according to the corresponding tactic positioning.

In an embodiment, the virtual competitive sports game further includes a virtual competitive object, and the processor 701 further executes: detecting whether the virtual competitive object is controlled by a first default virtual object in a starting point of the target tactic, where the first default virtual object is a virtual object that controls the virtual competitive object in the starting point of the target tactic; if not, controlling the virtual competitive object to be passed to the first default virtual object; and controlling the multiple virtual objects of the offensive side to move to starting positions of the target tactic; and then proceeding to the step of assigning the target virtual object to the tactic positioning corresponding to execution of the finishing competitive action in the target tactic.

In an embodiment, the processor 701, when executing the step of assigning the target virtual object to the tactic positioning corresponding to execution of the finishing competitive action in the target tactic, specifically executes: acquiring a second default virtual object in the target tactic, where the target tactic specifies that the finishing competitive action is to be executed by the second default virtual object with a target virtual role identity; and if a virtual role identity of the target virtual object matches the target virtual role identity, assigning the target virtual object to the tactic positioning corresponding to execution of the finishing competitive action; or if the virtual role identity of the target virtual object does not match the target virtual role identity, replacing tactic positioning of the target virtual object with tactic positioning of the second default virtual object.

In an embodiment, the processor 701, when executing the step of assigning the other virtual objects of the offensive side to the other tactic positioning in the target tactic, specifically executes: if the virtual role identity of the target virtual object does not match the target virtual role identity, keeping tactic positioning corresponding to remaining virtual objects of the offensive side, except for the second default virtual object and the target virtual object, unchanged; or assigning the remaining virtual objects of the offensive side to corresponding tactic positioning in the target tactic according to a priority order of virtual role identities of the remaining virtual objects in the virtual competitive sports game.

In an embodiment, the processor 701, when executing the step of assigning the other virtual objects of the offensive side to the other tactic positioning in the target tactic, specifically executes: if the virtual role identity of the target virtual object matches the target virtual role identity, keeping tactic positioning corresponding to the other virtual objects of the offensive side, except for the target virtual object unchanged; or assigning the other virtual objects of the offensive side to the other tactic positioning in the target tactic according to a priority order of virtual role identities of the other virtual objects in the virtual competitive sports game.

In an embodiment, the processor 701, when executing the step of determining a target tactic from candidate tactics supported by the target finishing zone, specifically executes: displaying at least one candidate tactic supported by the target finishing zone on the graphical user interface; and in response to a tactic selection operation for the at least one candidate tactic, determining the target tactic from the at least one candidate tactic.

In an embodiment, the processor 701, when executing the step of determining, based on the virtual field area, a selected target finishing zone for the offensive side to execute a finishing competitive action, specifically executes: presenting a zone matching control on the graphical user interface; in response to a control trigger operation for the zone matching control, presenting a tactical zone panel on the graphical user interface, where the tactical zone panel contains multiple tactical zones corresponding to the multiple finishing zones; and in response to a zone trigger operation for the multiple tactical zones, determining a finishing zone corresponding to a tactical zone triggered by the zone trigger operation as the selected target finishing zone for the offensive side to execute the finishing competitive action.

In an embodiment, the processor 701, when executing the step of presenting a zone matching control on the graphical user interface, specifically executes including: providing a tactic control on the graphical user interface; and in response to a control trigger operation for the tactic control, displaying at least one auxiliary control on the periphery of the tactic control, where the auxiliary control includes the zone matching control.

In an embodiment, the auxiliary control of the tactic control further includes a tactic browsing control, and the processor 701 further executes: in response to a control trigger operation for the tactic browsing control, presenting a tactical panel on the graphical user interface, where the tactical panel includes at least one tactic of the offensive side; in response to a tactic selection operation for the at least one tactic, determining the target tactic from the at least one tactic; and controlling the at least one virtual object manipulated by the offensive side to execute the target tactic.

In an embodiment, the auxiliary control of the tactic control further includes a virtual object designation control, and the processor 701 further executes: in response to a control trigger operation for the virtual object designation control, presenting a virtual object identifier of the at least one virtual object manipulated by the offensive side on the graphical user interface; in response to an identifier selection operation for the virtual object identifier, determining the target virtual object from the at least one virtual object; presenting a tactical panel on the graphical user interface, where the tactical panel includes at least one tactic of the offensive side; in response to a tactic selection operation for the at least one tactic, determining the target tactic from the at least one tactic; and controlling the target virtual object to execute the finishing competitive action corresponding to the target tactic based on the tactic positioning corresponding to the target tactic.

In an embodiment, the processor 701, when executing the step of determining, based on the virtual field area, a selected target finishing zone for the offensive side to execute a finishing competitive action, specifically executes: in response to a field trigger operation for the virtual field area of the virtual game screen, determining a finishing zone associated with the field trigger operation; and determining the finishing zone as the selected target finishing zone for the offensive side to execute the finishing competitive action.

In an embodiment, the offensive side includes multiple virtual objects, and from the at least one virtual object of the offensive side, the processor 701, when executing the step of determining, from at least one virtual object manipulated by the offensive side, a target virtual object that matches the target finishing zone, specifically executes: acquiring an offensive attribute value of the virtual object in the target finishing zone, or a historical efficiency value of the virtual object executing a target tactic in the target finishing zone; and determining a virtual object with the highest offensive attribute value or the highest historical efficiency value as the target virtual object.

For the specific implementations of the above operations, reference can be made to the previous embodiments, which will not be repeated here.

Optionally, as shown in FIG. 18, the electronic device 700 further includes: a touch display screen 703, a radio frequency circuit 704, an audio circuit 705, an input unit 706, and a power supply 707. The processor 701 is separately electrically connected to the touch display screen 703, the radio frequency circuit 704, the audio circuit 705, the input unit 706, and the power supply 707. It should be understood by those skilled in the art that the structure of the electronic device shown in FIG. 18 does not limit the electronic device. The device may include more or fewer components than shown, combine certain components, or adopt a different component arrangement.

The touch display screen 703 can be used to display a graphical user interface and receive operation commands generated by a user acting on the graphical user interface. The touch display screen 703 may include a display panel and a touch panel. The display panel can be used to display information input by the user or information provided to the user, and various graphical user interfaces of the electronic device. These graphical user interfaces can be composed of graphics, text, icons, videos, or any combination thereof. Optionally, the display panel may be configured in the form of a liquid crystal display (LCD) or an organic light-emitting diode (OLED), among others. The touch panel can be used to collect touch operations performed on or near it (e.g., operations by the user using a finger, stylus, or any other suitable object or accessory on or near the touch panel) and generate corresponding operation commands, which execute the corresponding programs. The touch panel may cover the display panel. When the touch panel detects a touch operation on or near it, the detected operation is transmitted to the processor 701 to determine the type of the touch event. Subsequently, the processor 701 provides the corresponding visual output on the display panel based on the type of the touch event. In the embodiments of the present disclosure, the touch panel and the display panel may be integrated into the touch display screen 703 to implement input and output functions. However, in some embodiments, the touch panel and the display panel may be implemented as two separate components to perform input and output functions independently. That is, the touch display screen 703 can also function as part of the input unit 706 to implement the input function.

In the embodiments of the present disclosure, the touch display screen 703 is used to present a graphical user interface and receive operation commands generated by the user acting on the graphical user interface.

The radio frequency circuit 704 can be used to send and receive radio frequency signals, so as to establish wireless communication with network devices or other electronic devices, and to send and receive signals with the network devices or other electronic devices.

The audio circuit 705 can provide an audio interface between the user and the electronic device through a speaker and a microphone. The audio circuit 705 can convert the received audio data into electrical signals and then transmit them to the speaker, which are then converted by the speaker into sound signals for output. Conversely, the microphone converts the collected sound signals into electrical signals, which are received by the audio circuit 705 and then converted into audio data. The audio data is then either output to the processor 701 for processing, or sent via the radio frequency circuit 704 to another electronic device, for example. Alternatively, the audio data is output to the memory 702 for further processing. The audio circuit 705 may also include an earphone jack to provide communication between peripheral headphones and the electronic device.

The input unit 706 can be used to receive input numerical or character information or user biometric information (e.g., fingerprints, iris data, facial information, etc.), and to generate signal inputs related to user settings and functional controls by means of a keyboard, mouse, joystick, optical device, or trackball.

The power supply 707 is used to supply power to the various components of the electronic device 700. Optionally, the power supply 707 can be logically connected to the processor 701 through a power management system, thereby enabling functions such as charging, discharging, and power consumption management to be performed via the power management system. The power supply 707 may also include one or more direct current (DC) or alternating current (AC) power supplies, a recharging system, a power failure detection circuit, a power converter or inverter, a power status indicator, or any other components.

Although not shown in FIG. 18, the electronic device 700 may also include a camera, a sensor, a Wi-Fi module, a Bluetooth module, and so on, which are not described here in detail.

In the above embodiments, each embodiment is described with its own emphasis, and for parts not detailed in a particular embodiment, reference can be made to the relevant descriptions in other embodiments.

It will be understood by those of ordinary skill in the art that all or part of the steps in the various methods of the above embodiments can be implemented through instructions or by controlling the relevant hardware via instructions. These instructions can be stored in a computer-readable storage medium and loaded and executed by a processor.

To this end, the embodiments of the present disclosure provide a computer-readable storage medium in which multiple computer programs are stored. These computer programs can be loaded by a processor to execute the steps of any virtual game control method according to the embodiments of the present disclosure. For example, the computer program can execute the following steps:
presenting a virtual game screen corresponding to a virtual competitive sports game on a graphical user interface of an electronic device, where the virtual game screen includes part or all of a virtual field area of the virtual competitive sports game, and the virtual competitive sports game includes at least two competing sides; when a competing side controlled by a virtual user corresponding to the electronic device is an offensive side, determining, based on the virtual field area, a selected target finishing zone for the offensive side to execute a finishing competitive action, where the target finishing zone is any one of multiple pre-determined finishing zones within the virtual field area, and the finishing competitive action includes a virtual competitive action for executing a virtual offense; determining, from at least one virtual object manipulated by the offensive side, a target virtual object that matches the target finishing zone; and controlling the target virtual object to execute a preparatory action for the finishing competitive action, or controlling the target virtual object to execute the preparatory action and to execute the finishing competitive action in the target finishing zone.

In an embodiment, the computer program further executes the following steps: determining a target tactic from candidate tactics supported by the target finishing zone, where the target tactic has corresponding tactic positioning, and the target tactic includes the finishing competitive action. Correspondingly, the step of controlling the target virtual object to execute the preparatory action and to execute the finishing competitive action in the target finishing zone includes: controlling the target virtual object to move into the target finishing zone based on the tactic positioning to execute the finishing competitive action corresponding to the target tactic.

In an embodiment, the offensive side includes multiple virtual objects, the target tactic further includes tactic positioning of the multiple virtual objects of the offensive side, and the step of controlling the target virtual object to move into the target finishing zone based on the tactic positioning to execute the finishing competitive action corresponding to the target tactic specifically includes: assigning the target virtual object to the tactic positioning corresponding to the virtual object executing the finishing competitive action in the target tactic; assigning the other virtual objects of the offensive side to the other corresponding tactic positioning in the target tactic; and controlling the target virtual object and the other virtual objects to execute the target tactic according to the corresponding tactic positioning.

In an embodiment, the virtual competitive sports game further includes a virtual competitive object, and the computer program further executes the following steps: detecting whether the virtual competitive object is controlled by a first default virtual object in a starting point of the target tactic, where the first default virtual object is a virtual object that controls the virtual competitive object in the starting point of the target tactic; if not, controlling the virtual competitive object to be passed to the first default virtual object; and controlling the multiple virtual objects of the offensive side to move to starting positions of the target tactic; and then proceeding to the step of assigning the target virtual object to the tactic positioning corresponding to execution of the finishing competitive action in the target tactic.

In an embodiment, the step of assigning the target virtual object to the tactic positioning corresponding to execution of the finishing competitive action in the target tactic includes: acquiring a second default virtual object in the target tactic, where the target tactic specifies that the finishing competitive action is to be executed by the second default virtual object with a target virtual role identity; and if a virtual role identity of the target virtual object matches the target virtual role identity, assigning the target virtual object to the tactic positioning corresponding to execution of the finishing competitive action; or if the virtual role identity of the target virtual object does not match the target virtual role identity, replacing tactic positioning of the target virtual object with tactic positioning of the second default virtual object.

In an embodiment, the step of assigning the other virtual objects of the offensive side to the other tactic positioning in the target tactic includes: if the virtual role identity of the target virtual object does not match the target virtual role identity, keeping tactic positioning corresponding to remaining virtual objects of the offensive side, except for the second default virtual object and the target virtual object, unchanged; or assigning the remaining virtual objects of the offensive side to corresponding tactic positioning in the target tactic according to a priority order of virtual role identities of the remaining virtual objects in the virtual competitive sports game.

In an embodiment, the step of assigning the other virtual objects of the offensive side to the other tactic positioning in the target tactic includes:
if the virtual role identity of the target virtual object matches the target virtual role identity, keeping tactic positioning corresponding to the other virtual objects of the offensive side, except for the target virtual object unchanged; or assigning the other virtual objects of the offensive side to the other tactic positioning in the target tactic according to a priority order of virtual role identities of the other virtual objects in the virtual competitive sports game.

In an embodiment, the step of determining a target tactic from candidate tactics supported by the target finishing zone includes: displaying at least one candidate tactic supported by the target finishing zone on the graphical user interface; and in response to a tactic selection operation for the at least one candidate tactic, determining the target tactic from the at least one candidate tactic.

In an embodiment, the step of determining, based on the virtual field area, a selected target finishing zone for the offensive side to execute a finishing competitive action includes: presenting a zone matching control on the graphical user interface; in response to a control trigger operation for the zone matching control, presenting a tactical zone panel on the graphical user interface, where the tactical zone panel contains multiple tactical zones corresponding to the multiple finishing zones; and in response to a zone trigger operation for the multiple tactical zones, determining a finishing zone corresponding to a tactical zone triggered by the zone trigger operation as the selected target finishing zone for the offensive side to execute the finishing competitive action.

In an embodiment, the step of presenting a zone matching control on the graphical user interface includes: providing a tactic control on the graphical user interface; and in response to a control trigger operation for the tactic control, displaying at least one auxiliary control on the periphery of the tactic control, where the auxiliary control includes the zone matching control.

In an embodiment, the auxiliary control of the tactic control further includes a tactic browsing control, and the computer program further executes the following steps: in response to a control trigger operation for the tactic browsing control, presenting a tactical panel on the graphical user interface, where the tactical panel includes at least one tactic of the offensive side; in response to a tactic selection operation for the at least one tactic, determining the target tactic from the at least one tactic; and controlling the at least one virtual object manipulated by the offensive side to execute the target tactic.

In an embodiment, the auxiliary control of the tactic control further includes a virtual object designation control, and the computer program further executes the following steps: in response to a control trigger operation for the virtual object designation control, presenting a virtual object identifier of the at least one virtual object manipulated by the offensive side on the graphical user interface; in response to an identifier selection operation for the virtual object identifier, determining the target virtual object from the at least one virtual object; presenting a tactical panel on the graphical user interface, where the tactical panel includes at least one tactic of the offensive side; in response to a tactic selection operation for the at least one tactic, determining the target tactic from the at least one tactic; and controlling the target virtual object to execute the finishing competitive action corresponding to the target tactic based on the tactic positioning corresponding to the target tactic.

In an embodiment, the step of determining, based on the virtual field area, a selected target finishing zone for the offensive side to execute a finishing competitive action includes: in response to a field trigger operation for the virtual field area of the virtual game screen, determining a finishing zone associated with the field trigger operation; and determining the finishing zone as the selected target finishing zone for the offensive side to execute the finishing competitive action.

In an embodiment, the offensive side includes multiple virtual objects, and from at least one virtual object of the offensive side, the step of determining, from at least one virtual object manipulated by the offensive side, a target virtual object that matches the target finishing zone includes: determining candidate virtual objects in the target finishing zone from the multiple virtual objects manipulated by the offensive side; acquiring the offensive attribute values of the candidate virtual objects; and determining a candidate virtual object with the highest offensive attribute value among the candidate virtual objects as the target virtual object that meets a preset offensive condition.

For the specific implementations of the above operations, reference can be made to the previous embodiments, which will not be repeated here.

The storage medium may include a read only memory (ROM), random access memory (RAM), magnetic disk, optical disk, or the like.

As the computer program stored in the storage medium can execute the steps in any virtual game control method according to the embodiments of the present disclosure, it can achieve the beneficial effects that can be achieved by any virtual game control method according to the embodiments of the present disclosure. For details, reference can be made to the previous embodiments, which will not be repeated here.

The above has provided a detailed description of a virtual game control method and apparatus, a storage medium, and an electronic device according to the embodiments of the present disclosure. Specific examples are applied herein to elaborate on the principles and implementations of the present disclosure. The descriptions of the above embodiments are merely intended to facilitate understanding of the methods of the present disclosure and core ideas thereof. Meanwhile, for those skilled in the art, changes in specific implementations and application scopes may be made based on the ideas of the present disclosure. In summary, the content of this specification should not be construed as a limitation of the present disclosure.

1. virtual game control method, comprising:
presenting a virtual game screen corresponding to a virtual competitive sports game on a graphical user interface of an electronic device, wherein the virtual game screen comprises at least a part of a virtual field area of the virtual competitive sports game, and the virtual competitive sports game comprises at least two competing sides;
in response to determining that a competing side controlled by a virtual user corresponding to the electronic device is an offensive side, determining, based on the virtual field area, a target finishing zone for the offensive side to execute a finishing competitive action, wherein the target finishing zone comprises one of a plurality of pre-determined finishing zones within the virtual field area, and the finishing competitive action comprises a virtual competitive action for executing a virtual offense;
determining, from one or more virtual objects manipulated by the offensive side, a target virtual object that matches the target finishing zone; and
in response to the determination of the target virtual object:
controlling the target virtual object to execute a preparatory action for the finishing competitive action, or
controlling the target virtual object to execute the preparatory action and to execute the finishing competitive action in the target finishing zone.

2. The virtual game control method according to claim 1, further comprising:
determining a target tactic from one or more candidate tactics supported by the target finishing zone, wherein the target tactic comprises a corresponding tactic positioning and the finishing competitive action, and controlling the target virtual object to execute the preparatory action and to execute the finishing competitive action in the target finishing zone comprises:
controlling the target virtual object to move into the target finishing zone based on the tactic positioning to execute the finishing competitive action corresponding to the target tactic.

3. The virtual game control method according to claim 2, wherein the offensive side comprises a plurality of other virtual objects, the target tactic further comprises a plurality of other tactic positionings for the plurality of other virtual objects of the offensive side, and wherein controlling the target virtual object to move into the target finishing zone based on the tactic positioning to execute the finishing competitive action corresponding to the target tactic comprises:
assigning the target virtual object to the tactic positioning corresponding to execution of the finishing competitive action in the target tactic;
assigning the plurality of other virtual objects of the offensive side to the plurality of other tactic positionings in the target tactic; and
controlling the target virtual object and the plurality of other virtual objects to execute the target tactic according to the corresponding tactic positioning.

4. The virtual game control method according to claim 3, wherein the virtual competitive sports game further comprises a virtual competitive object, and the virtual game control method further comprises:
detecting whether the virtual competitive object is controlled by a first default virtual object in a starting point of the target tactic,
in response to determining that the virtual competitive object is not controlled by the first default virtual object in the starting point of the target tactic: controlling the virtual competitive object to be passed to the first default virtual object; and
controlling the plurality of other virtual objects of the offensive side to move to starting positions of the target tactic; and
assigning the target virtual object to the tactic positioning corresponding to execution of the finishing competitive action in the target tactic.

5. The virtual game control method according to claim 3, wherein assigning the target virtual object to the tactic positioning corresponding to execution of the finishing competitive action in the target tactic comprises:
acquiring a second default virtual object in the target tactic, wherein the target tactic specifies that the finishing competitive action is to be executed by the second default virtual object with a target virtual role identity; and
in response to determining that a virtual role identity of the target virtual object matches the target virtual role identity, assigning the target virtual object to the tactic positioning corresponding to execution of the finishing competitive action, or in response to determining that the virtual role identity of the target virtual object fails to match the target virtual role identity, replacing the tactic positioning of the target virtual object with a tactic positioning of the second default virtual object.

6. The virtual game control method according to claim 5, wherein assigning the plurality of other virtual objects of the offensive side to the plurality of other tactic positionings in the target tactic comprises:
in response to determining that the virtual role identity of the target virtual object fails to match the target virtual role identity, keeping the plurality of other tactic positionings corresponding to remaining virtual objects of the offensive side, except for the second default virtual object and the target virtual object, unchanged; or
assigning the remaining virtual objects of the offensive side to corresponding tactic positionings in the target tactic according to a priority order of virtual role identities of the remaining virtual objects in the virtual competitive sports game.

7. The virtual game control method according to claim 5, wherein assigning the plurality of other virtual objects of the offensive side to the plurality of other tactic positionings in the target tactic comprises:
in response to determining that the virtual role identity of the target virtual object matches the target virtual role identity, keeping the plurality of other tactic positionings to the plurality of other virtual objects of the offensive side, except for the target virtual object, unchanged; or
assigning the plurality of other virtual objects of the offensive side to the plurality of other tactic positionings in the target tactic according to a priority order of virtual role identities of the other virtual objects in the virtual competitive sports game.

8. The virtual game control method according to claim 2, wherein determining a target tactic from the one or more candidate tactics supported by the target finishing zone comprises:
displaying the one or more candidate tactics supported by the target finishing zone on the graphical user interface; and
in response to a tactic selection operation for the one or more candidate tactics, determining the target tactic from the one or more candidate tactics.

9. The virtual game control method according to claim 1, wherein determining, based on the virtual field area, the target finishing zone for the offensive side to execute the finishing competitive action comprises:
presenting a zone matching control on the graphical user interface;
in response to a control trigger operation for the zone matching control, presenting a tactical zone panel on the graphical user interface, wherein the tactical zone panel comprises a plurality of tactical zones corresponding to the plurality of pre-determined finishing zones; and
in response to a zone trigger operation for the plurality of tactical zones, determining a finishing zone corresponding to a tactical zone triggered by the zone trigger operation as the target finishing zone for the offensive side to execute the finishing competitive action.

10. The virtual game control method according to claim 9, wherein presenting the zone matching control on the graphical user interface comprises:
providing a tactic control on the graphical user interface; and
in response to a control trigger operation for the tactic control, displaying an auxiliary control on a periphery of the tactic control, wherein the auxiliary control comprises the zone matching control.

11. The virtual game control method according to claim 10, wherein the auxiliary control of the tactic control further comprises a tactic browsing control, the virtual game control method further comprising:
in response to a control trigger operation for the tactic browsing control, presenting a tactical panel on the graphical user interface, wherein the tactical panel comprises one or more tactics of the offensive side;
in response to a tactic selection operation for the one or more tactics tactic, determining a target tactic from the one or more tactics; and
controlling the one or more virtual objects manipulated by the offensive side to execute the target tactic.

12. The virtual game control method according to claim 10, wherein the auxiliary control of the tactic control further comprises a virtual object designation control, the virtual game control method further comprising:
in response to a control trigger operation for the virtual object designation control, presenting a virtual object identifier of the one or more virtual objects manipulated by the offensive side on the graphical user interface;
in response to an identifier selection operation for the virtual object identifier, determining the target virtual object from the one or more virtual objects;
presenting a tactical panel on the graphical user interface, wherein the tactical panel comprises one or more tactics of the offensive side;
in response to a tactic selection operation for the one or more tactics, determining a target tactic from the one or more tactics; and
controlling the target virtual object to execute the finishing competitive action corresponding to the target tactic based on the tactic positioning corresponding to the target tactic.

13. The virtual game control method according to claim 1, wherein determining, based on the virtual field area, the target finishing zone for the offensive side to execute the finishing competitive action comprises:
in response to a field trigger operation for the virtual field area of the virtual game screen, determining a finishing zone associated with the field trigger operation; and
determining the finishing zone as the target finishing zone for the offensive side to execute the finishing competitive action.

14. The virtual game control method according to claim 1, wherein the offensive side comprises a plurality of virtual objects, and determining, from the one or more virtual objects manipulated by the offensive side, the target virtual object that matches the target finishing zone comprises:
acquiring an offensive attribute value of the virtual object in the target finishing zone, or a historical efficiency value of the virtual object executing a target tactic in the target finishing zone; and
determining a virtual object with the highest offensive attribute value or the highest historical efficiency value as the target virtual object.

15. (canceled)

16. One or more non-transitory computer-readable storage media containing, in any combination, computer program code that, when executable by a computer system, perform an operation comprising:
presenting a virtual game screen corresponding to a virtual competitive sports game on a graphical user interface of an electronic device, wherein the virtual game screen comprises at least a part of a virtual field area of the virtual competitive sports game, and the virtual competitive sports game comprises at least two competing sides;
in response to determining that a competing side controlled by a virtual user corresponding to the electronic device is an offensive side, determining, based on the virtual field area, a target finishing zone for the offensive side to execute a finishing competitive action, wherein the target finishing zone comprises one of a plurality of pre-determined finishing zones within the virtual field area, and the finishing competitive action comprises a virtual competitive action for executing a virtual offense;
determining, from one or more virtual objects manipulated by the offensive side, a target virtual object that matches the target finishing zone; and
in response to the determination of the target virtual object:
controlling the target virtual object to execute a preparatory action for the finishing competitive action, or
controlling the target virtual object to execute the preparatory action and to execute the finishing competitive action in the target finishing zone.

17. A system, comprising:
one or more memories collectively containing one or more programs; and
one or more processors, wherein the one or more processors are configured to, individually or collectively, perform an operation comprising:
presenting a virtual game screen corresponding to a virtual competitive sports game on a graphical user interface of an electronic device, wherein the virtual game screen comprises at least a part of a virtual field area of the virtual competitive sports game, and the virtual competitive sports game comprises at least two competing sides;
in response to determining that a competing side controlled by a virtual user corresponding to the electronic device is an offensive side, determining, based on the virtual field area, a target finishing zone for the offensive side to execute a finishing competitive action, wherein the target finishing zone comprises one of a plurality of pre-determined finishing zones within the virtual field area, and the finishing competitive action comprises a virtual competitive action for executing a virtual offense;
determining, from one or more virtual objects manipulated by the offensive side, a target virtual object that matches the target finishing zone; and
in response to the determination of the target virtual object:
controlling the target virtual object to execute a preparatory action for the finishing competitive action, or
controlling the target virtual object to execute the preparatory action and to execute the finishing competitive action in the target finishing zone.

18. The one or more non-transitory computer-readable storage media of claim 16, wherein the operation further comprises:
determining a target tactic from one or more candidate tactics supported by the target finishing zone, wherein the target tactic comprises a corresponding tactic positioning and the finishing competitive action, and
controlling the target virtual object to execute the preparatory action and to execute the finishing competitive action in the target finishing zone comprises:
controlling the target virtual object to move into the target finishing zone based on the tactic positioning to execute the finishing competitive action corresponding to the target tactic.

19. The one or more non-transitory computer-readable storage media of claim 18, wherein the offensive side comprises a plurality of other virtual objects, the target tactic further comprises a plurality of other tactic positionings for the plurality of other virtual objects of the offensive side, and wherein controlling the target virtual object to move into the target finishing zone based on the tactic positioning to execute the finishing competitive action corresponding to the target tactic comprises:
assigning the target virtual object to the tactic positioning corresponding to execution of the finishing competitive action in the target tactic;
assigning the plurality of other virtual objects of the offensive side to the plurality of other tactic positionings in the target tactic; and
controlling the target virtual object and the plurality of other virtual objects to execute the target tactic according to the corresponding tactic positioning.

20. The one or more non-transitory computer-readable storage media of claim 16, wherein determining, based on the virtual field area, the target finishing zone for the offensive side to execute the finishing competitive action comprises:
presenting a zone matching control on the graphical user interface;
in response to a control trigger operation for the zone matching control, presenting a tactical zone panel on the graphical user interface, wherein the tactical zone panel comprises a plurality of tactical zones corresponding to the plurality of pre-determined finishing zones; and
in response to a zone trigger operation for the plurality of tactical zones, determining a finishing zone corresponding to a tactical zone triggered by the zone trigger operation as the target finishing zone for the offensive side to execute the finishing competitive action.

21. The one or more non-transitory computer-readable storage media of claim 16, wherein the offensive side comprises a plurality of virtual objects, and determining, from the one or more virtual objects manipulated by the offensive side, the target virtual object that matches the target finishing zone comprises:
acquiring an offensive attribute value of the virtual object in the target finishing zone, or a historical efficiency value of the virtual object executing a target tactic in the target finishing zone; and
determining a virtual object with the highest offensive attribute value or the highest historical efficiency value as the target virtual object.
